(19) United States
(12) Patent Application Publication
(10) Pub. No.: US 2006/0182582 A1
(43) Pub. Date: Aug. 17, 2006

(54) Hand truck/forklift aparatus

(76) Inventor: George Sharpton, Atlanta, GA (US)

Correspondence Address: George Sharpton, P O Box 161576, Atlanta, GA, 30321, US

(21) Appl. No.: 10/470,653

(22) Filed: Oct. 8, 2004

(51) Int. Cl. B60P 1/00

(52) U.S. Cl. 414/542

(57) ABSTRACT

The hand truck/forklift as disclosed in this application is new and useful as an improvement in manually operated lifting trolleys in that it is versatile, fast, safe, practical and user friendly for transporting and lifting loads commonly carried on a hand truck, and with the preferred optional use of an electric hoist and cable actuating assembly lift apparatus overcomes some limitations of use in enclosed environments and (or) raised structurally spanned floors without special provisions for excessive air changes or special structural reinforcements in floor construction as would be required for most power operated lifting trolleys currently available for lifting weights comparable to the lifters body weight or heavier. This lift assembly is versatile in that it may be used is a basic lifting trolley with various optional features which include a mountable base carriage trolley, an extensible mast and cable or chain assemblies, the parallel actuating arm (rotary frame) or the lift actuating electric hoist to lift loads less than or comparable to the lifters body weight. When this lift apparatus is used in this most basic form it lifts loads faster and in some cases safer and efficiently when compared to other manually operated lifting trolleys. The rotary frame of the manually operated lift assembly is preferably adapted with a sleeved punched post assembly at the outer end with a spring loaded caliper and pin assembly operated by a hand controlled lever on the rear frame extension and a sleeved cable to secure the load at selected heights, and to serve as a safeguard for holding the raised load on the lift fork. The optional addition of the parallel lifting arm to the extensible mast even further increases the vertical lifting height and frontal range of the lift apparatus including lifting from depths beyond the level of the loading dock. This invention in either form can also be used as a practical, versatile, convenient, fast and economical supplement to conventional hand trucks and forklifts by transporting and lifting loads onto and from delivery trucks to work counters, shelves, standard hand trucks etc. and stacking loaded pallet units for handling by heavier conventional lifts for improved efficiency in either indoor or outside material handling operations, and yet capable without the optional extensible mast and its actuating rear mounted jack assembly of being manually loaded onto a delivery truck to perform these lifting functions at stops along the truck route. The present lift apparatus is also equipped with an electric hoist significantly reduce the resultant impact of stopping on structurally suspended floors, avoid tilt-over, to maximize the frontal, height and depth range of the lift trolley apparatus and actuate mounting and subsequent dismounting with the use of an electric winch and cable all in succession based on the relative resistance to movement of the lift assembly components in this continuous hoist cable pulling motion with all lift trolley features mounted and by means of the optional use of cables or chains and reverse movement of the lift trolley A-frame and the indirectly attached load fork to dismount the carriage trolley.

### CROSS REFERENCES TO RELATED APPLICATIONS

Related U.S. Application Data

Int. CI.-6 - - - B60P 1/02

U.S. Cl. - - - 214/674; 414/495; 254/4 R; 254/4 C

Field of Search - - - 414/490, 495; 214/670;
254/4R, 4 C, 5 B, 5 C, 10 C;
187/233,231

### REFERENCES CITED

U.S. Patent Documents:

U.S. Pat. No. 5,681,139 10/1997 Szanto - - - 414/495

U.S. Pat. No. 5,681,154 04/1997 Irons, Jr. et al. - - - 414/622

U.S. Pat. No. 4,699,560 10/1987 Ostermeyer et al. - - - 414/917xR

U.S. Pat. No. 3,826,393 07/1974 Carroll - - - 214/674

U.S. Pat. No. 2,940,625 06/1960 Holm - - - 414/664

U.S. Pat. No. 2,152,849 04/1939 Hennessy - - - 254/4C

U.S. Pat. No. 368,883 10/1887 Forbes - - - 254/4C

Foreign Patent Documents:

367,545 5/1990 EP - - - 414/917

2,392,929 2/1979 FRENCH - - - 187/236

1,273,421 7/1968 GERMAN - - - 187/231

1,062,653 4/1954 FRENCH - - - 187/231

### SATEMENT REGARDING FEDERALLY SPONSORED RESEARCH OR DEVELOPMENT

“Not Applicable”

### REFERENCE TO SEQUENCE LISTING

“Not Applicable”

### BACKGROUND OF INVENTION

1. Field of Invention

The present invention pertains to manually operated Lifting Trolleys with a preferred option of using a power operated electric hoist when used to supplement lifting operations and transporting loads for short distances having weight comparable to the lift operator's body weight under any spatial condition and lifting light commercial and industrial loads in enclosed spaces with a maximum live load design of 100 pounds per square foot. The basic assembly of the simplest mode of the present lift apparatus lifts a load from the floor to at least the various heights to delivery trucks and work benches and the more complex assembly with electric motors and extensible mast(s) lifts a loads to heights comparable to those of conventional masts with extensible masts, and provides a means of lifting such loads in spaces which are not accessible to conventional power operated lifts where the use of such lifts are restricted because they are either too heavy or too wide, and in some cases environmentally restricted and on floors where use of motorized lifts with brake systems are prohibited by building codes for design reasons having to do with lateral forces. In some cases it is not economically feasible to have multiple or a power operated forklifts for such light loads. The lift trolley of the present invention is new and useful as one which is used to lower the extensible mast for lifting loads from a surface lower than that on which the lift trolley sets. The extensible mast is lowered and raised to a preferred setting height preferably by means of a rear mounted electrically operated hoist and chain or a balanced cable assembly. This lift trolley as disclosed in the original application is adaptable to the conventional application a power operated hydraulic jack and chain or balanced cable assembly only when the lift is used in a well vented or outdoor location.

The present invention was conceived as a mobile load handling retractable assembly with an attached rotary mast which was discovered as a result of designing a means of lifting an assembly of hinged connected floor-to-wall-to roof panels for an improvement in U.S. Pat. No. 3,857,211

2. Description of Related Art

In regard to previous inventions the Lifting Trolley, U.S. Pat. No. 5,681,139, which is primarily used to lift such loads racks of bread in a bakery is actuated functions by use of the hand held lever principally in the same manner as the present invention accept that it only has only one lever frame lift as opposed to a radial on-folding pivotal assembly of levers which are connected to each at their outer end by means of flexible cables. The lift trolley also feature spring loaded frame latch assemblies which engage to lock the load in at desired heights.

As with the present invention the Elevating Truck, U.S. Pat. No. 2,152,849 which is a manually operated lift is effectively designed to lift a load clear of the floor for movement such similar to what is commonly referred to as a common used pallet jack. This lift apparatus has proven to be effective, efficient and safe to use for moving heavy loads across the floor.

Another related invention, titled Combined Truck and Jack U.S. Pat. No. 368,833 and perhaps the earliest in this class of art, also features a pivoting ratchet action lever which is connected to a rotary frame by means chains running across a series of cogwheels is capable of lifting a load on a high rotary frame. This lift is apparatus is strong, but is severely limited in terms of speed of operation.

Two of the power operated hydraulic lifts referenced above as related art though capable of lifting heavier weights and being self propelled are each functionally similar to the present art in one or more aspects, but they cannot function without use the hydraulic systems they use as actuating mechanisms which primarily restricts them to open spaces. The Self Propelled Unloader, U.S. Pat. No. 3,826,393, like the invention of the present art is designed to shift the center of gravity when loaded to avoid tilting over and therefore it too does not need the counter weights for which most spanned floors of most buildings are not designed to support, but this lift is restricted to outdoor use unless the space in which it is used is especially highly ventilated; which is rare and most often the use of fuel powered engines are not permitted. On the other hand the Material Lift Truck, U.S. Pat. No. 2,940,625, is similar to the present art in that it features a rotary frame on an extensible mast. However, this lift is not capable of shifting the center of gravity when loaded, and therefore cannot function without the additional heavy built-in counter weights which most spanned floors of buildings are not designed to support. This lift apparatus too unlike the present invention must always be operated in an open or specially ventilated environment.

It is the object of the present invention as related the other manual lifts is to provide a folding wheel lever assembly operated by use of ones hands and feet to enhance leverage and control by assuring maximum leverage in the initial stage of lifting as opposed to having to exert excess effort relative to body weight and height of the lifter. As with the single lever of the Lifting Trolley the first lever frame of the present invention is set at approximately 90 degrees to the horizontal base plane of the load to be lifted the operator will experience great difficulty in the initial stage of lifting or the final stage of lowering the load.

In the absence of a sufficient power source it is the object of this invention to provide additional levers in the folding wheel assembly because without the aid of lower radiated levers it is very difficult to initiate lifting weights comparable to the lifters body weight, and conversely and most importantly one would not be able to maintain leverage of such a load when the load is taken from a raised position requiring less leverage.

In the absence of a sufficient power source it is the object of this invention to provide the folding wheel of levers because without the lower levers of assembly the operator would progressively and very rapidly lose of control of the lift apparatus which is likely to result injury to the operator, and anyone else within range of the uncontrolled falling load as well as causing the compounded loss of the load any resulting collateral damage or injury.

In the absence of a power source it is the object of this invention to add the rotary chain of levers because the absence the use of additional levers results in progressively rapid rotation of the manually operated lever arms and therefore does not allow the operator to engage the spring loaded latch assembly to stop the rapidly descending load which forces the lever upward, and this rapid Notion would not allow the operator the lift operator to select heights at which he can set the load fork on the lift mast.

It is also the preferred object of this invention to provide the added feature of the front and rear mounted chain prop assemblies which enables greater take-up in the 90 degree angle as opposed to the hypotenuse connection which results in less take up when such props are not used.

It is the object of the present invention to avoid the use of an extremely long lever frame which the lift operator would literally have to hand walk upward to achieve some leverage if at all. The present invention allows the use of a rotary chain with the length of each lever being equal to or greater than of the corresponding front mounted rotary lift mass to which the lift fork is attached. Proportionately longer levers with respect the length of the front mounted rotary frame of the present invention proportionately increases leverage on the rear lever side.

As with the present invention the Elevating Truck lift apparatus has been proven to be effective, efficient and safe to use for moving heavy loads across the floor. However, the lift does not enable one to lift loads to work bench and truck bed heights as can be achieved with the present invention.

The use of another hand operated lever arm called the winch is used to wind cable about its axis and thereby lift the load to which the cable is attached on the other end as featured in previously issued U.S. Pat. Nos. 2,702,095, 3,876,039, 3,957, 137, 4,015,686, 4,131,181, 4,987,976 4,546,853 and 4,987,976 are capable of lifting such loads as those lifted by the present art to higher heights, but the rate at which lifting occurs is much slower and presents imminent hazards of personal bodily injury if one loses grip on the lever handle for whatever reason. Even thou most in-door lifting operations are achieved today under most conditions by use of battery powered lifts such as those with various extensible mass assemblies. These battery powered lifts cause no environmental impact, but they are still impractical to use in many indoor locations which have either structural or spatial limitations relative to the weight and width of such lift units respectively. These battery power operated lift tends to be wider than most interior doors in office buildings, convenience stores, kitchens, houses and similar buildings which might have narrow doors and in some cases have floors which are not designed to carry the sustained loads of power operated lifts which require the use of built-in counter weights to avoid tilting over.

In the absence of a power source it is the object the present invention to provide a lighter lift apparatus by applying the operators body weight as leverage only during the lifting process with the option to add counter weights to the base of the lift when needed. The present invention avoids the absolute need for counter weights by shifting the load on the front posts of the lift frame assembly to the center of the base carriage when used to prevent tilt-over or enabling the operator to use his body weight to off-set the load.

It is object of this invention to provide an optional swivel wheeled narrow mobile platform with a pair channels forming tracks on which the frame of lift assembly moves back-and-forth by means of trolley wheels to achieve leverage and load distribution with heavy bulky mounted loads, and to allow the lift assembly to navigate tight spaces and lifting and lowering loads to relatively lower platform heights.

It is the object of this invention to provide an optional vertical trolley mounted extensible mast on the front frame mounted channel track assembly to which a cubical or barrel shaped bulky load is optionally attached using straps. This mast is preferably operated by means of a pair of balanced cable assemblies designed to operate the front and rear pivoting connections of the parallel arm, and is optionally lifted by means of chains attached to levers with the chains running across a rear mounted propped chain/cable assembly as described the present invention.

Relative to the present invention there continues to be problems and limitations with previous manually lever operated lifting trolleys with regard mainly to lifting height range, speed of lifting, degrees of difficulty in lifting with regard to lift cable connection points relative to lever length. The problems persist variably with the various current inventions and thereby restrict the use of such lifts in various lifting operations beyond their effective range of use. Even though most of these lifts can be used independently and effectively or as a supplementary device for other lifting mechanisms in a variety of material handling operations their effective use is restricted for lifting loads of 100 to 300 pounds to the height of delivery and transport truck beds and waist high work benches with speed and relative ease.

The object of the present invention is to provide a lifting trolley to be used independently and where needed as a supplement to other lifts of greater height and weight lifting capacities to overcome the restrictions which are inherent in previous inventions, and enable lifting of such loads as discussed in the previous paragraph in all spaces accessible to hand trucks effectively and efficiently without difficulty, excessive physical exertion and personal bodily injury to the operator.

### SUMMARY OF INVENTION

The present invention, titled An Improvement in a Hand Truck Forklift Apparatus, is an improvement in a lifting trolley comprising the equivalent of manually actuated levers which are actuated by the preferred means a pair of balanced cable assemblies as newly disclosed in this continuing CIP application or the secondary option of a chain and cogwheel assembly as disclosed in the original application to raise and lower mounted parallel lift arms supported by a folding A-frame on wheels as used in various lifting trolleys of the prior art. This lift is further improved by the preferred option of using a preferred electric motor driven hoist and balanced cable assembly as newly disclosed is this continuing application as a preference over the hydraulic jack as disclosed in the original application as a lift actuating means. The hydraulic jack assembly is only a conventional means of providing secondary option of using the system to lift heavier loads in outdoor conditions. Unlike conventional fork lifts the present lifting trolley is not mounted on a motor driven chassis with a break system as designed in the original application of this continuing application (CIP). All references to such a chassis are abandoned in-as-much-as the intended use of the present lift apparatus is to be used in spaces where such lifts with drive chassis are prohibited by building codes for structural and or environmental reasons as further explained in this application.

The lift apparatus of the present art is an improvement in lifting trolleys of the prior art or a combination thereof with the optional addition of a fan of interconnected levers to establish safety, speed of operation and achieve maximum leverage to lift loads. This lifting trolley is a further improvement of those of the prior art or a combination thereof with the addition of an optionally preferred extensible mast which is actuated by means of a rear mounted lift assembly.

This lift trolley is an improvement over prior art in that it employs an improved retractable A-frame on a dis-mountable undercarriage to achieve load distribution when mounted and the flexibility of use in terms of maneuvering, handling, transporting and storing the lift trolley when not in use to make it more user friendly. The lifting trolley of the present art embodies a multiplicity of improvements that would have been badly needed by but not envisioned by inventors of those of the prior art to achieve comparable lifting.

The lift is further improved for use as a portable user friendly light weight trolley lift assembly to lift loads comparable to the lifters body weight safely and with minimum effort for short distances in both indoor and outside conditions. This versatile lift assembly is also improved by use of an optionally used extensible mast, rear jack assembly and a retractable and dis-mountable base trolley as described herein. This lift trolley when assembled without the optional rear jack and extensible mast assemblies is capable of being lifted onto delivery trucks by one person to be used at stops along the route. The most basic form of this lift assembly in which the optionally mounted rotary lift frame is removed offers less lifting reach, but is most manageable by one person and yet capable of lifting a load vertically up the front channel tracks of the a-frame assembly to the height of a delivery truck bed. This lift is designed to manually lift various light industrial, commercial, light utility, freight, retail deliveries, automotive shop, approved ambulatory and household appliances loads.

The present invention is further improved by the use of a pair rear mounted and top frame mounted balanced cable and parallel bars which are actuated by an electric hoist with a series of looped cable patterns which are used to pull balanced parallel bars back and fourth along the frames as illustrated on the drawing and explained in the Description Of The Invention, or by means of a power operated hydraulic jack and chain assembly when the lift is used in a well-vented or outdoor location to lift or lower the front mounted extensible mast to which both the bulky load is directly attached and preferably the rotary frame is attached as described herein using longer chains as required to make up the difference in length relative to the lower platform height.

The lifting capacity of the manually operated hand truck/lift assembly is limited directly to the body weight of the operator which serves as the lifting force and counter-weight on the load. The limit of the raised unattended load on the lift fork when supported by the by the sleeved post prop assembly is determined by the size of the counter weight(s) positioned on the base frame of the lift on the opposite side of the rotary mast frame. However, the operator is capable of lifting a weight equal to the operator's weight plus the weight which the operator is capable of lifting from a bent knee position with his back in a vertically upright posture to a vertically straight legged upright posture. This lift apparatus can be used by a person with a back injury to lift a load equaling his or her body weight and this person would not sustain further injury from this effort. The full rotary height of the load on the rotary lift mast can be achieved by successively stepping on the rotating foot bars on the lever side and exerting knee lift pressure while the operators hands are griped to the handles at the end of the lift chain prop assembly on the lever side of the lift. Therefore the size of lift frame posts, chains and the various component assemblies must be designed to lift loads by an operator having the highest combination of both body weight and lift strength, or specific lifts must be designed with load lift limits. Offsetting counter weights must also be sized accordingly when the lift is not counter balanced by shifting the load on a mobile carriage.

The maximum load on the rotary lift is greatest when the load on the fork is rotated such that the pivotal frame of the rotary mast frame is in its it's extreme horizontal position. The lever of the manually operated fork lift/hand truck is correspondingly set to align in a horizontal plane with the rotary mast for the greatest leverage. The maximum lift height of the load on the manually operated lift is typically 4 feet six inches. However, this height can be greater if the length of the rotary mast is longer. The use of the electric hoist increases the lifting height in proportion to the length and the number of extensible masts used.

The rotary lift mast of the manually operated version of this lift apparatus is always supported at its outer rotary end by use of a sleeved and punched channel assembly on casters which is pin locked at selected heights to hold the forklift tongue at fixed positions when the lever arms are not counter balanced.

The base frame assembly for this forklift/hand truck is retractable on an interlocking trolley channel track assembly. The bilateral chain assembly is balanced by axle connected cogwheel assemblies attached to the base frame and to the extensible masts of the forklift/hand truck assemblies.

The base frame channels of this lift assembly are of a standard size, but may vary in metals made of aluminum, metal alloys or stainless steel for unit weight and lift strength design variations. These channel frames may be doubled back-to-back for added strength. Larger channels, chains, wheels and trolleys would also be used for units of higher lift capacity.

The power actuated lift apparatus as newly introduced in this continuing CIP application is new and useful as a comprehensive improvement in a lifting trolley where-in an electric hoist with cable and hook is used as a primary means to actuate the three functions of mounting of the lift fork onto a carriage trolley, shifting the lift fork on the carriage trolley and actuating the lift masts of the lift trolley which are used to lift the load fork systematically and automatically in three successive stages with balanced cable assemblies to achieve maximum load distribution, significantly reduce the resultant impact of stopping on structurally suspended floors, avoid tilt-over, to maximize the frontal, height and range of the lift trolley apparatus and actuate mounting and subsequent dismounting with the aid of an electric winch and cable all in succession based on the relative resistance to movement of the lift assembly components in a continuous motion with all lift trolley features mounted and by means of the optional use of cables and the use of an electric winch to actuate forward movement of the lift trolley A-frame and enable the indirectly attached load fork to dismount the carriage trolley;

The conclusion is that the present invention in its either of it's various modes of assembly is new and useful in that a combination of the features of lifts apparatuses of prior art can not be assembled without the use of several other new features to achieve the same or comparable ends for lifting in an indoor environment on floors not specially designed for motorized lifts. It is also concluded that the lift of the present art will be new and useful as a manual or power operated supplement to heavier motorized lifts in that it allows access to spaces which can not be accessed by conventional lifts because of either ventilation, structural or spatial requirements. It is further concluded that the present invention will not replace but will supplement use of other lift systems of the prior art in a material handling operation. It is ultimately concluded that the present invention will be successful in eliminating many of the back injuries occurring in spaces commonly not served by power operated lifts of the present art for various reasons.

### DESCRIPTION OF DRAWINGS

FIGS. 1 through 14 illustrates the lift of the present art using chains and cogwheels which are actuated preferably by a manually operated chain of levers with an optional rear mounted hydraulic jack assembly as disclosed in the original application for this invention, and FIGS. 15 through 25 illustrate a balanced cable system which is preferably actuated by means of an electric hoist motor, and capability being operated by the supplemental use of a pair of manually operated levers when the levers are less than 45 degrees to the horizontal plane.

FIG. 1 illustrates the three dimensional view of the lift assembly in the manually operated mode with lever handles to operate the rotary flame by means of chain and cogwheel assemblies about a mobile centrally positioned ‘A’ frame assembly which functions as a fulcrum in this lever operated lift assembly. This figure also features front and rear mounted chain prop frame assemblies mounted on both sides of the rotary lift mast and the lever operating assemblies respectively. This drawing also illustrates a counter weight located on the central base of the connecting ‘A’ flame panel which is used to leverage loads on the list fork supported by the sleeved post prop assembly in the absence of the operators body weight. See elevations and sectional views as referenced on this plan.

FIG. 2 illustrates the plan view the base section of the manually operated hand truck/lift assembly without the swivel wheeled platform as described in FIG. 1 above.

FIG. 3 illustrates the plan view of the lower section of the manually operated hand truck/lift assembly as described in FIG. 1 above without the optional swivel wheeled platform.

FIG. 4 illustrates the upper section plan view of the manually operated forklift assembly without the optional swivel wheeled platform.

FIG. 4A shows an enlargement of the rear upper frame connection of the manually operated A-frame lift assembly.

FIG. 4A shows an enlargement of the front upper frame connection of the manually operated A-frame lift assembly.

FIG. 5 illustrates a detail view of the lever handle and foot plate assembly in the lower rotated position as referenced in FIG. 3.

FIG. 5A illustrates an enlargement of the lower rear area as referenced in FIG. 5.

FIG. 6 illustrates the frontal view of the manual operated hand truck/lift assembly on a swivel wheeled platform as described in FIG. 1 above without the swivel wheeled platform.

FIG. 7 illustrates a detailed sectional view of the combined lever arm assembly.

FIG. 8 illustrates the side view of the manually operated hand truck/lift assembly as described in FIG. 1 above without the swivel wheeled platform.

FIG. 9 illustrates a sectional view of the basic manually operated hand truck/lift assembly at the extreme downward rotation of the rotary mast frame with axle mounted wheels and rear mounted wheels mounted to the base frame of the a frame assembly with load fork in the upright position without the swivel wheeled platform as illustrated in FIG. 1.

FIG. 10 illustrates a sectional view of the basic manually operated hand truck/lift assembly as described in FIG. 9 above with the load in a fold-up compact tilted position to ease transport by concentrating the center of gravity of weight toward the front wheels of the unit. The rear swivel wheel assembly on the rear post frame is adjustable about a tubular slotted sleeved assembly with removable pins for pivotal tilting of the load. This figure also illustrates the levers and the chain prop assemblies in their folded positions to reduce the length of the hand truck/lift assembly movement through tight areas and to require less space for storage of unit with or without a load. The folding of the A-frame and the connecting horizontal base panel at it pivotal center to form an even more compact lift trolley is also illustrated in dashed lines.

FIG. 11 illustrates a plan view of the lift assembly on the optional and dis-mountable swivel wheeled platform with rear mounted jacks as referenced in FIGS. 5, 12, 13 and 14.

FIG. 16A illustrates an enlargement of upper rear A-frame connection with channel trolleys, chain and cogwheels as referenced in FIG. 11.

FIG. 16B illustrates an enlargement of upper front A-frame connection with channel trolleys, chain and cogwheels at extensible masts as referenced in FIG. 11.

FIG. 16c illustrates an enlargement of upper front parallel arm to lift fork connection with chain and cogwheels at the lift fork as referenced in FIG. 11.

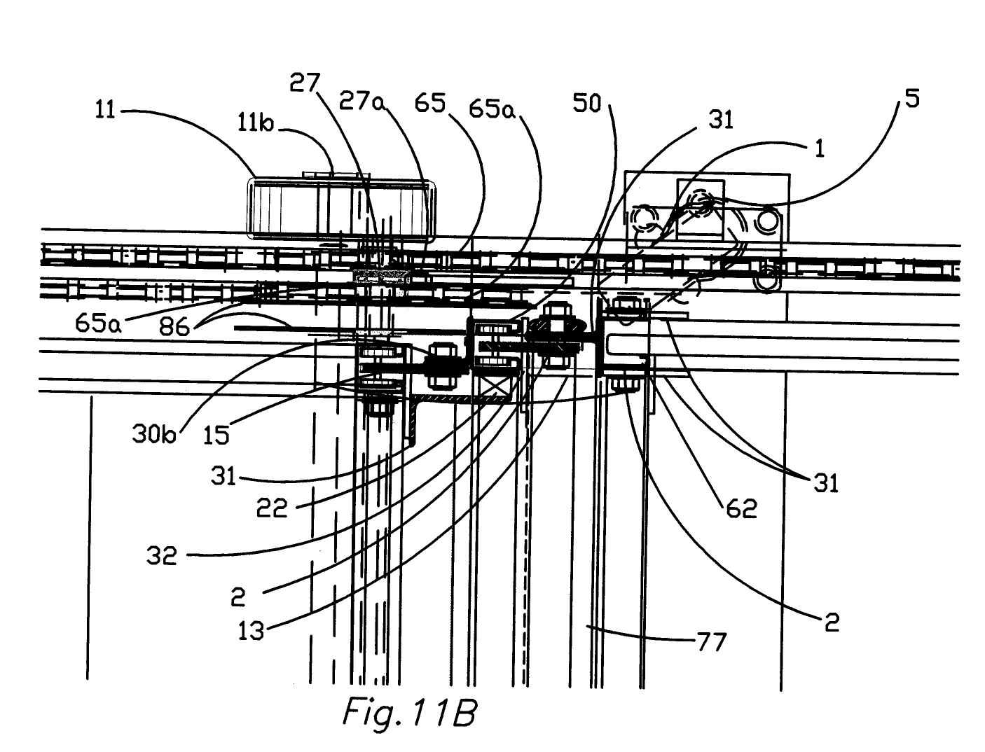

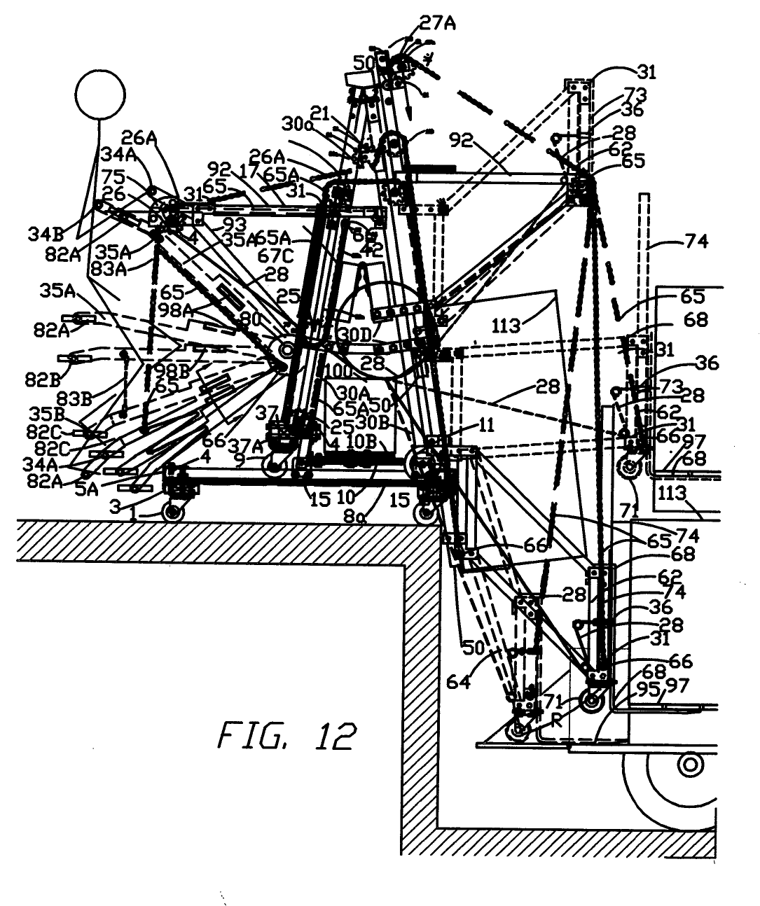

FIG. 12 illustrates the manual A-frame lift trolley at the edge of a loading dock with a parallel arm having the lift fork extended to lift a load from a pallet with a minimum 6 inch high base in a rotary swing from the bed of a pick-up truck at a lower level.

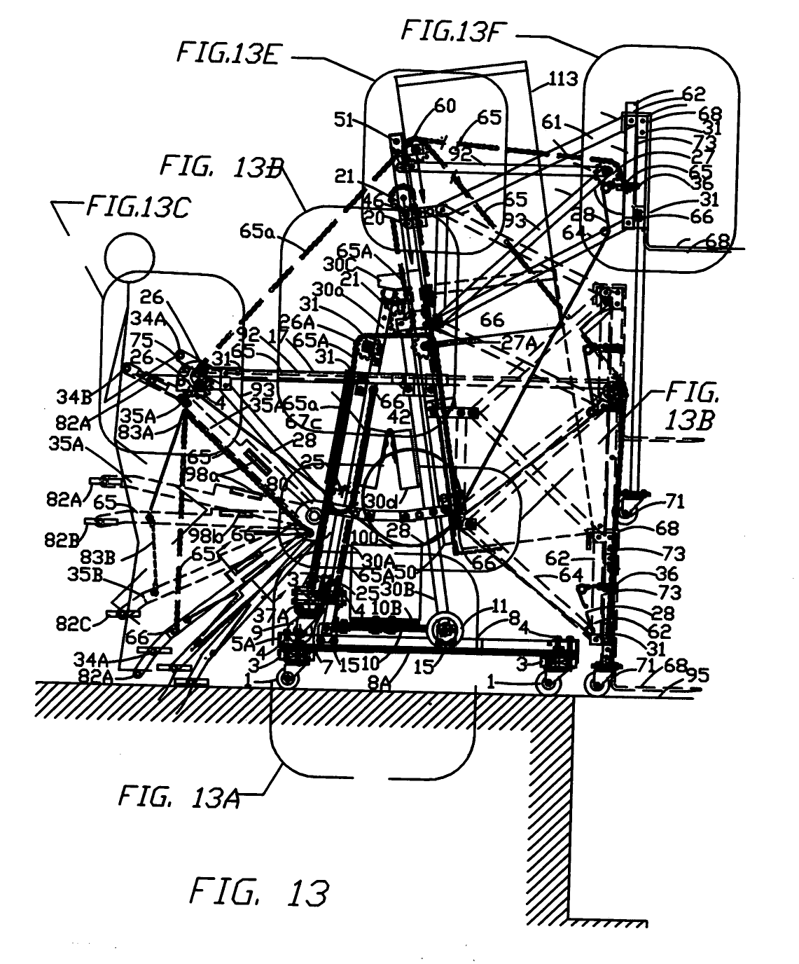

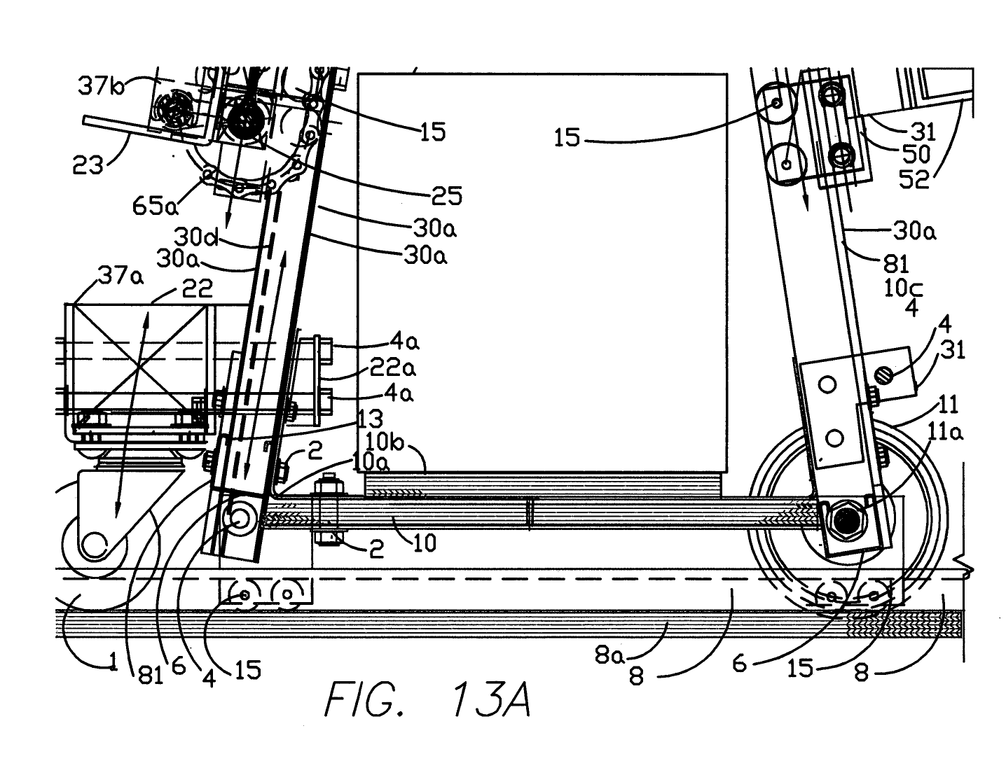

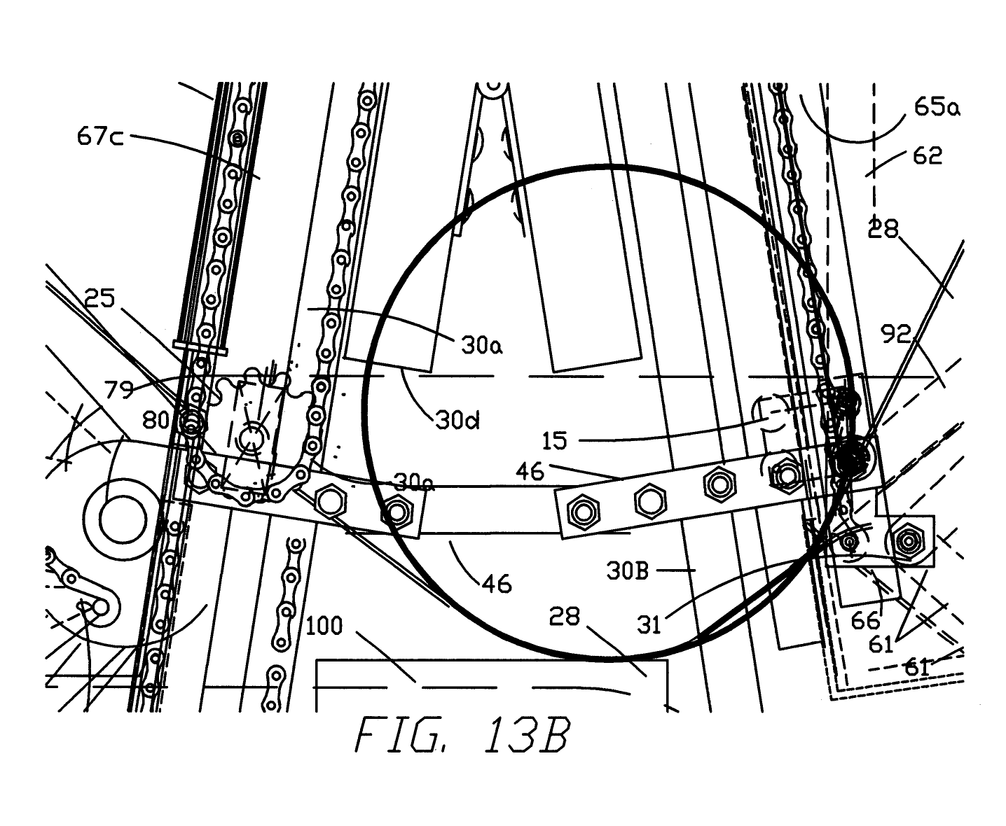

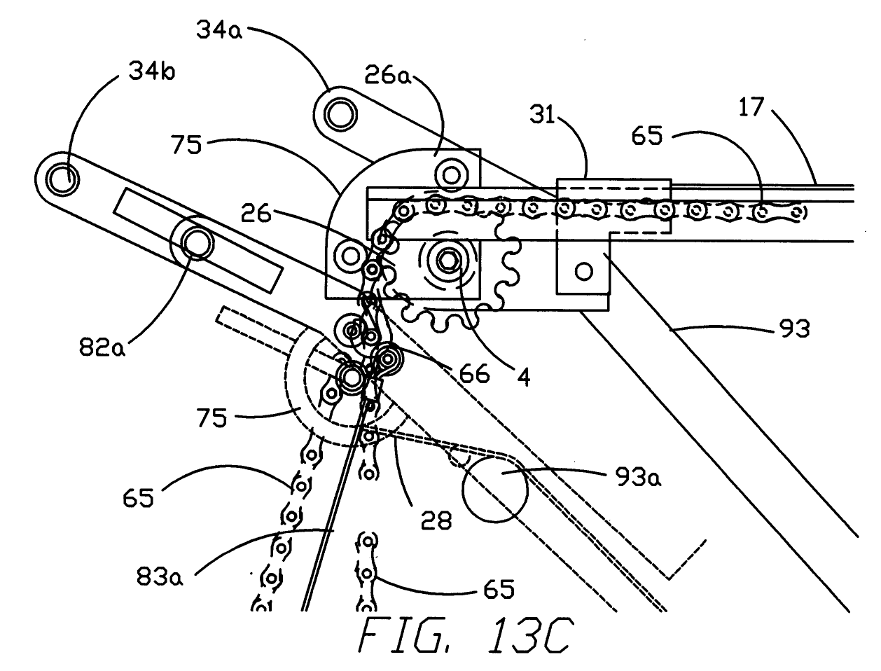

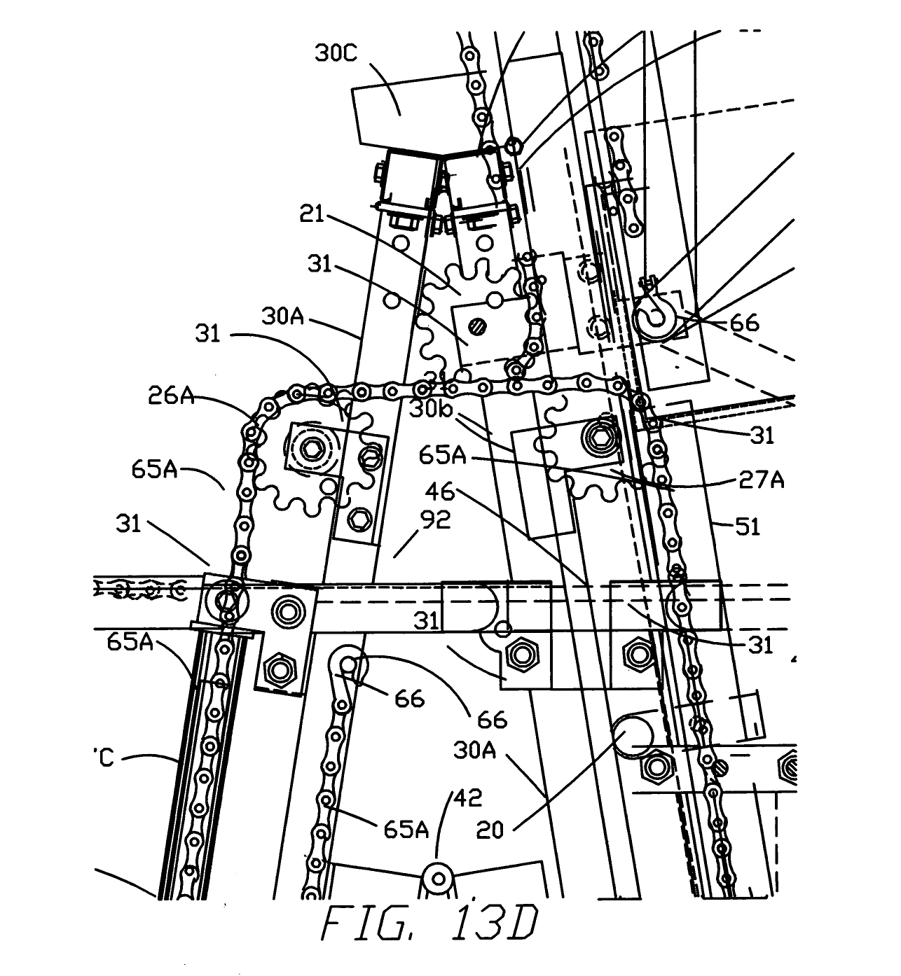

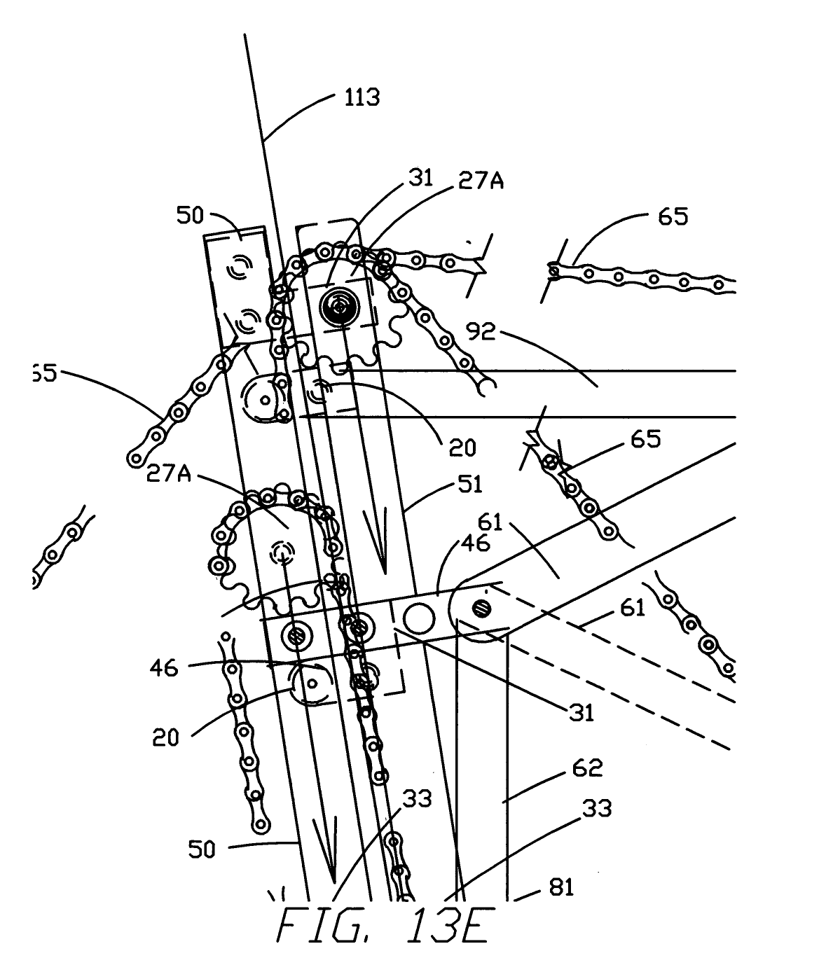

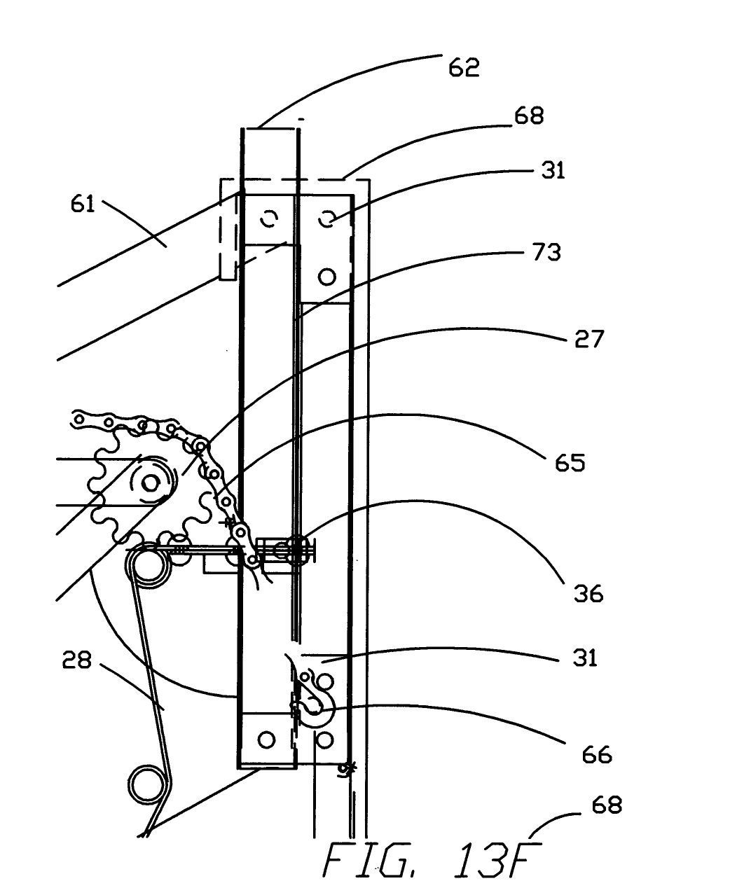

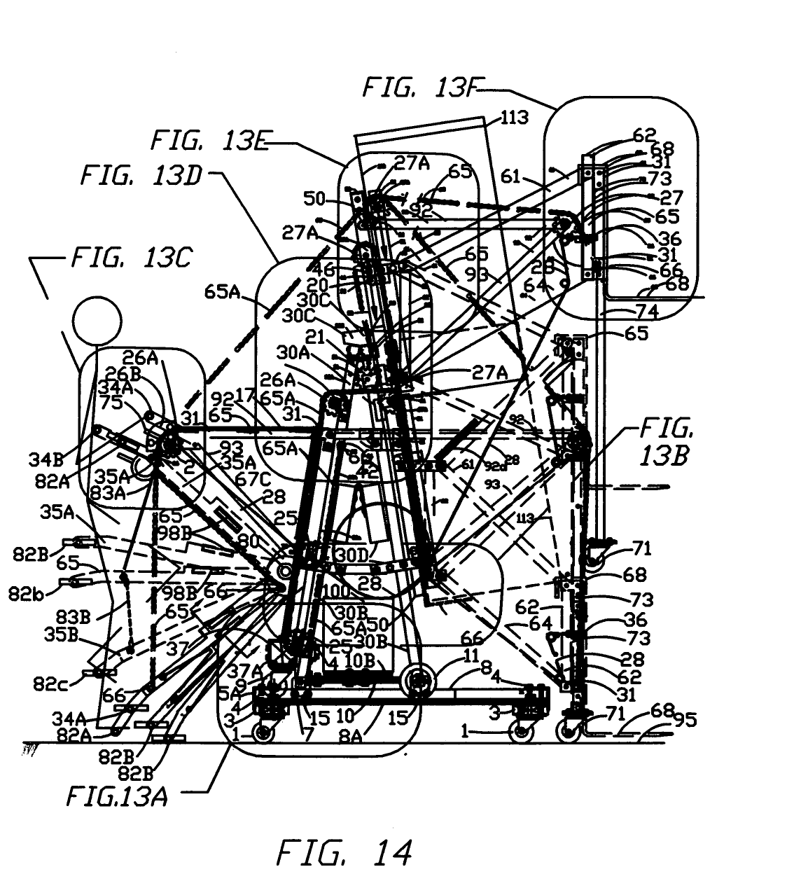

FIG. 13 illustrates the side view of the manually operated hand truck/lift assembly as described in FIG. 12 with a raised rotary lift frame when the lift is mounted optional and dis-mountable swivel wheeled platform on trolley wheels to allow for rearward positioning of the A frame on the tracks allowing the raised load to stand without counter weight on a rad swivel wheeled platform, and shows the rotary frame with the lift fork at various raised positions above the raised platform surface with the lift apparatus

FIG. 13A illustrates an enlarged view of the relative hydraulic jack actuated chain and cogwheel arrangements on metal brackets on the connecting plate between rear A-frame posts.

FIG. 13B illustrates an enlarged view of lower mid height connecting plates and hinges of the A-frame assembly at the sleeved post pin cable loop with the lift hook on the traveling front frame mounted extensible mast and the corresponding rear frame extending hydraulic jack actuated chain and cogwheel positioned near the fixed pivot plate of the lever arm

FIG. 13C illustrates an enlarged view of the rear handle positions relative to the rear prop frame connection at the rearmost cogwheel with chains.

FIG. 13D illustrates an enlarged view of the upper A-frame connection featuring central connections of the prop frame, and A-frame connections with hydraulic jack, cogwheel and chain connections.

FIG. 13E illustrates an enlarged view of the upper extensible mast connections at prop frame parallel arm and chain and cogwheel arrangements.

FIG. 13F illustrates an enlarged view at the parallel arm to lift fork and chain and cogwheel connections.

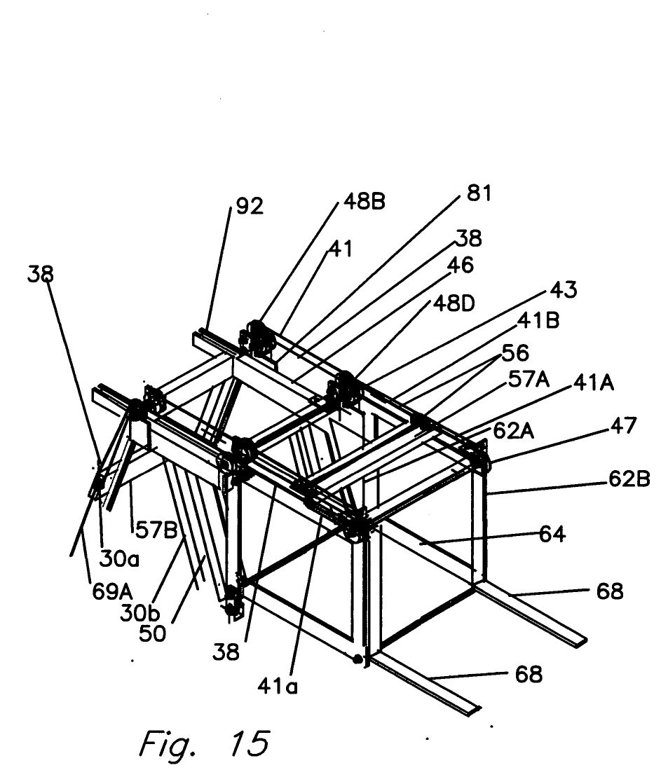

FIG. 14 illustrates the side view of the manually operated hand truck/lift assembly as described in FIG. 12 with a rotary lift frame when the lift is mounted optional and dis-mountable swivel wheeled is raised to it highest level with the extended mast raised, and shows the rotary frame with the lift fork at various raised positions above the raised platform surface with the lift apparatus moved back such that the raised load may be placed on the raised platform. This view also shows how the sleeved post is used to hold the tubular sleeve while the pivoting rotary frame is raised at the lift side to raise the inner pivot height of the rotary mast to elevate load on outer rotary frame to its highest level. The sleeved post is raised and held to the tubular sleeve on the rotary frame until the rotary mast is lowered again to a height that allows the swivel wheel based sleeved post to rest on the floor. This view also shows the front wheels of the A-frame positioned for maximum load distribution on the carriage trolley

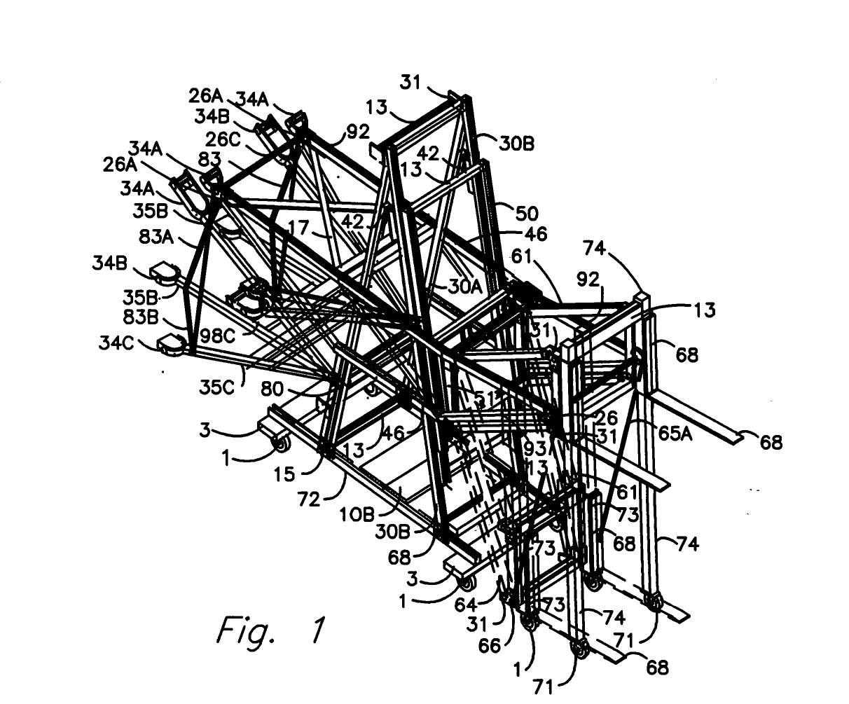

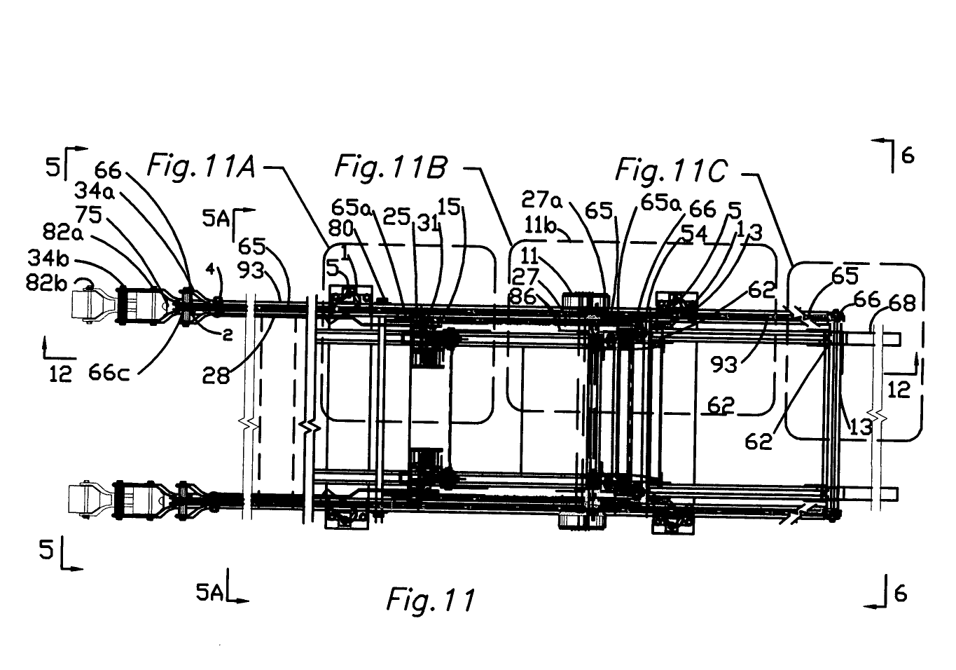

FIG. 15 illustrates a 3-dimensional partial view of the cable operated A-frame and parallel arm with lift fork, but without the optional application of the extensible mast, lever arm and prop frame assemblies as illustrated in FIGS. 1, 12, 13, and 19. This mode of assembly uses the electric hoist with the rear frame and parallel arm frame mounted balanced parallel bar and cable assemblies to actuate lifting of the load fork. See FIGS. 11, 17, 18 and 19 for electric hoist and cable.

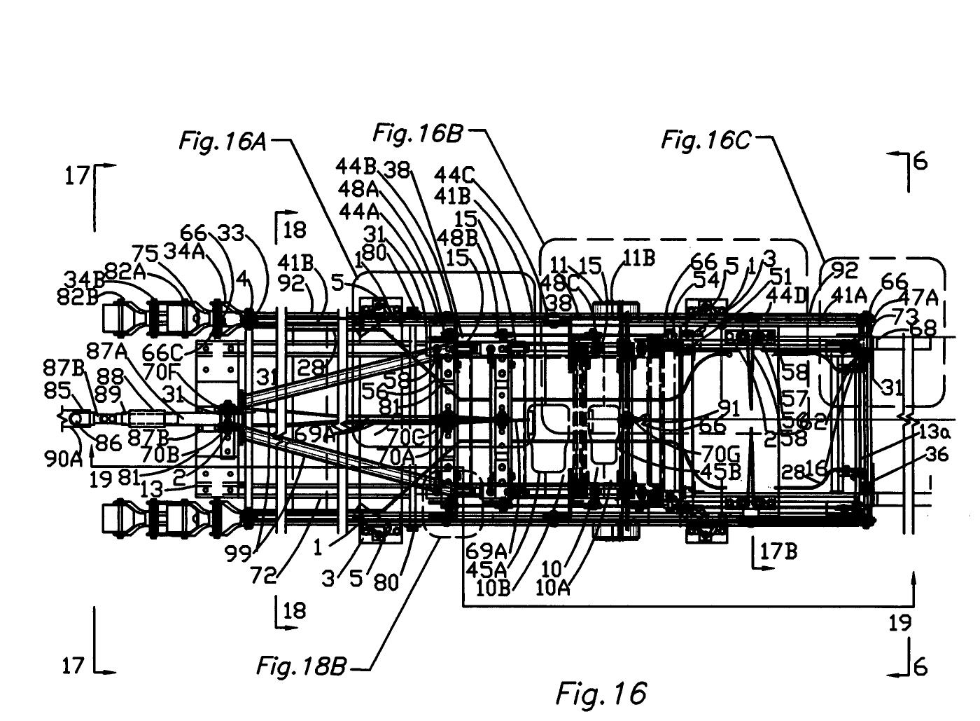

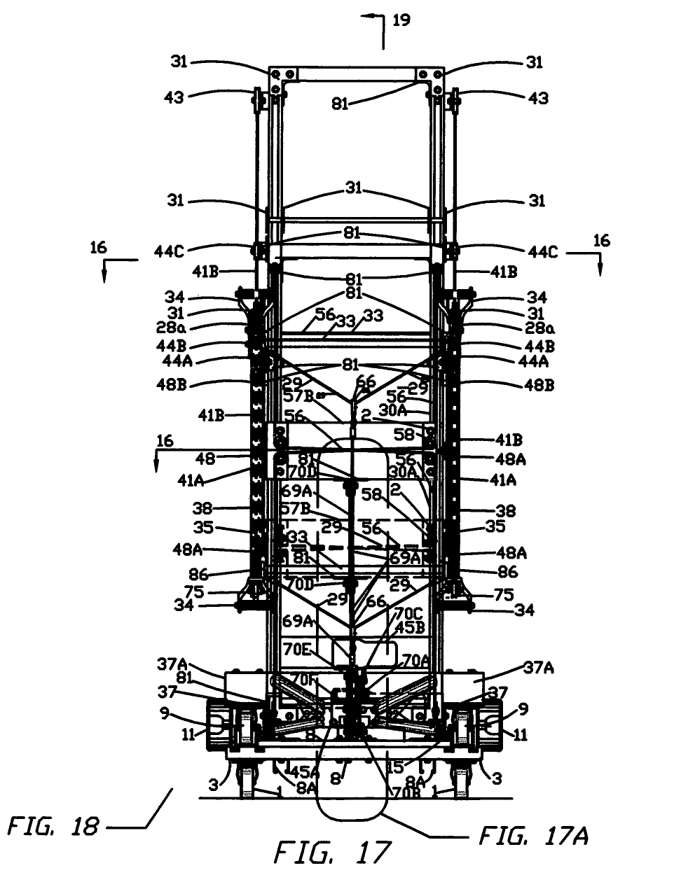

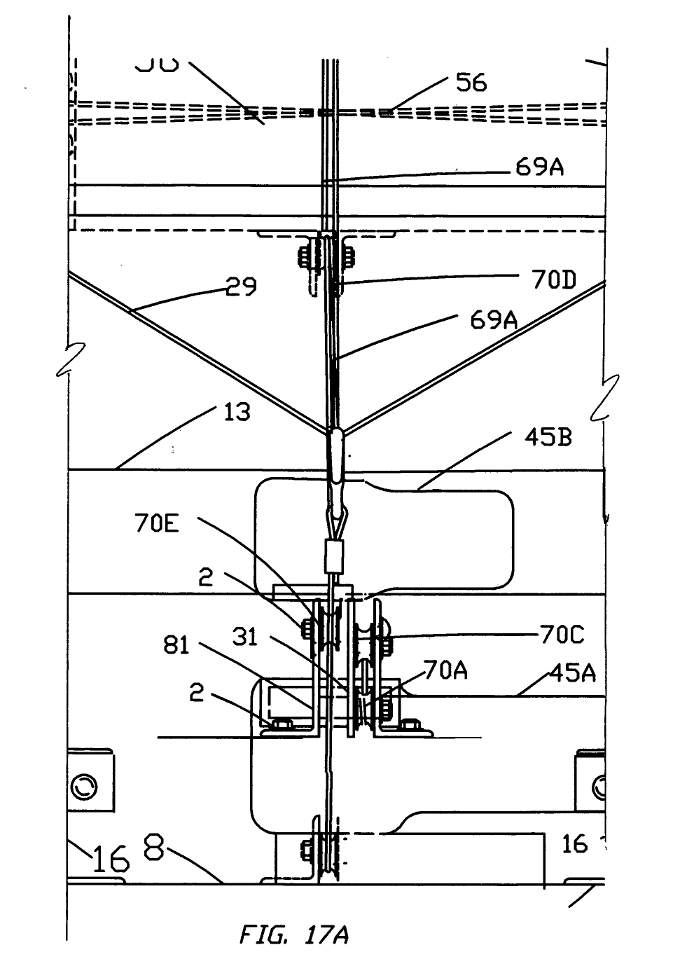

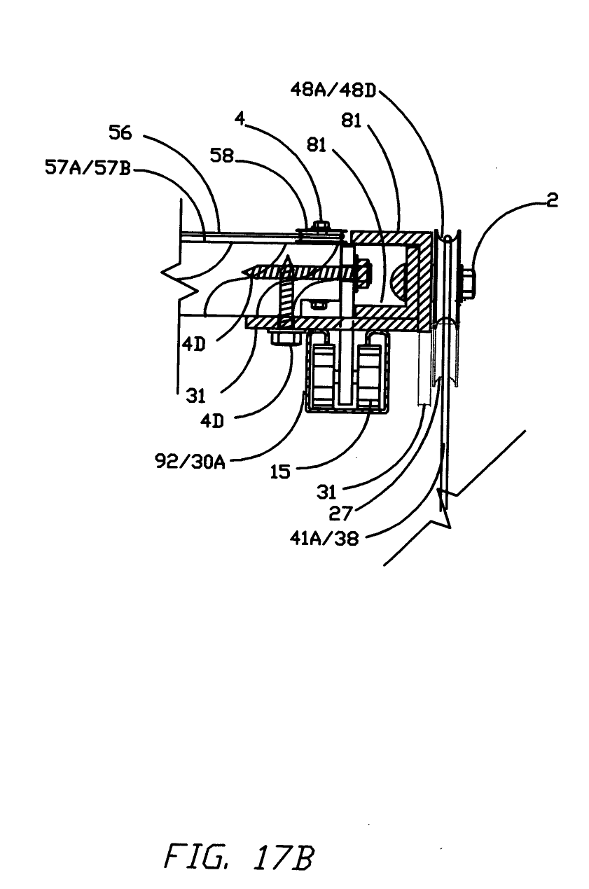

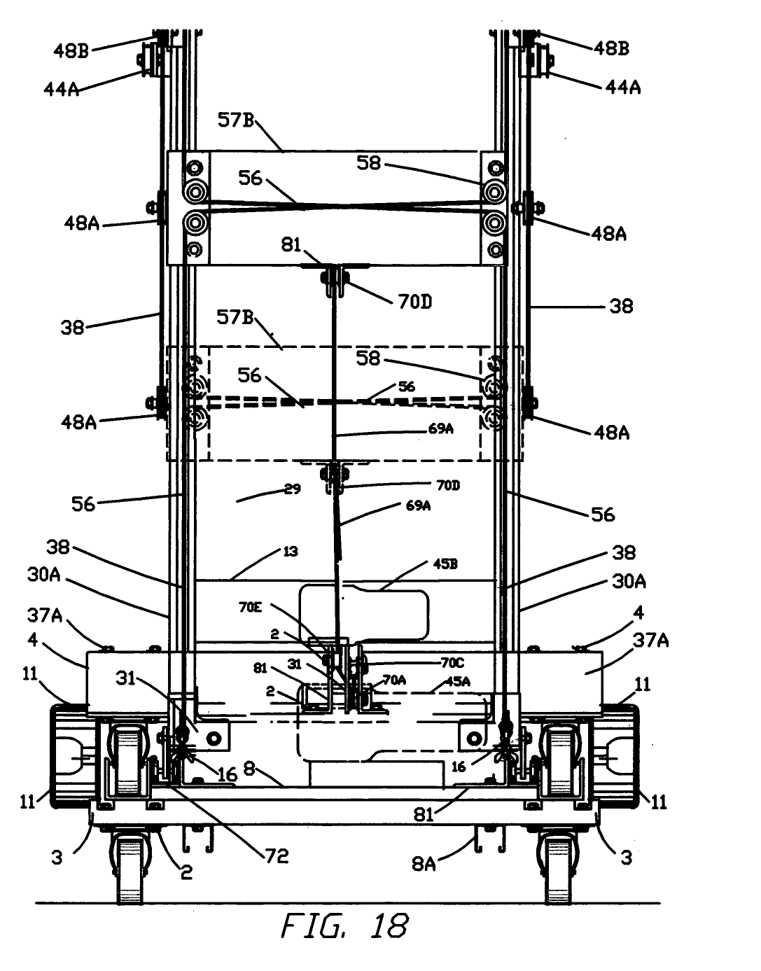

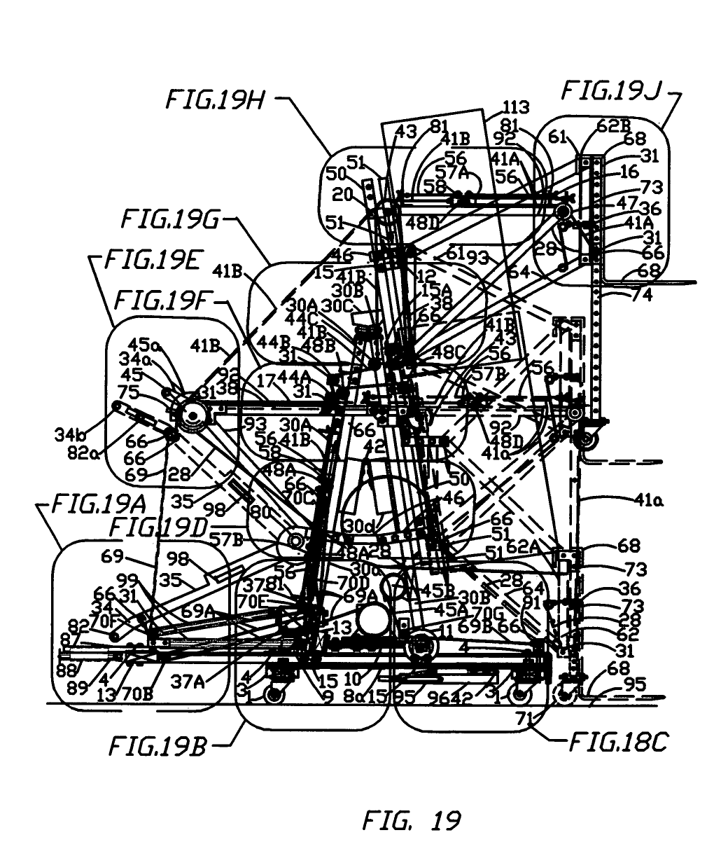

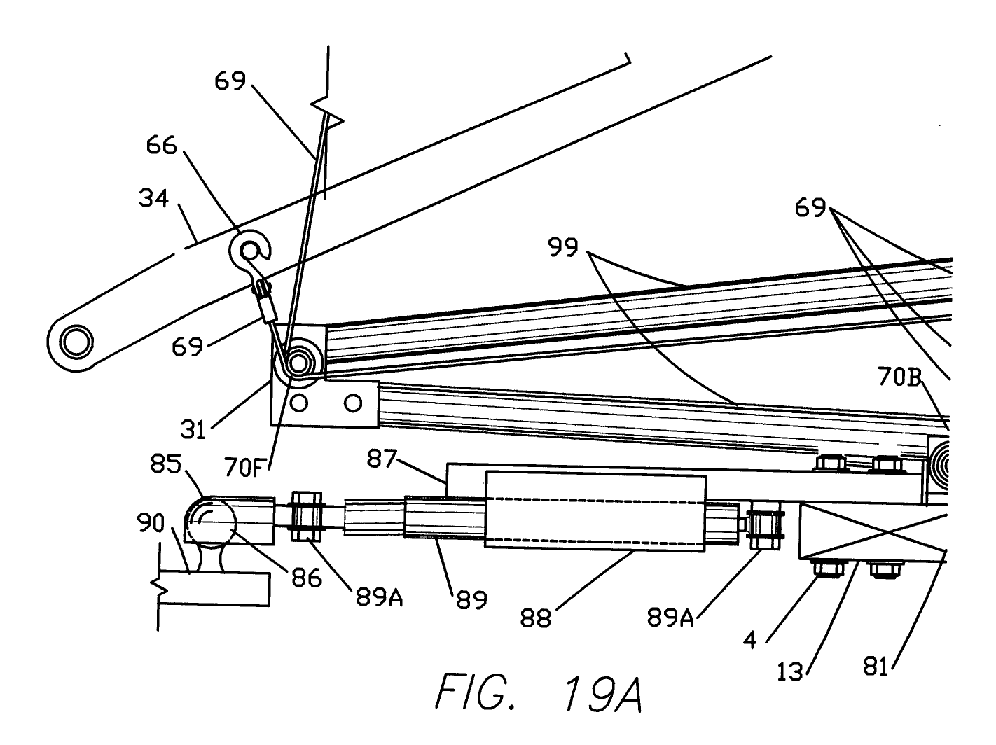

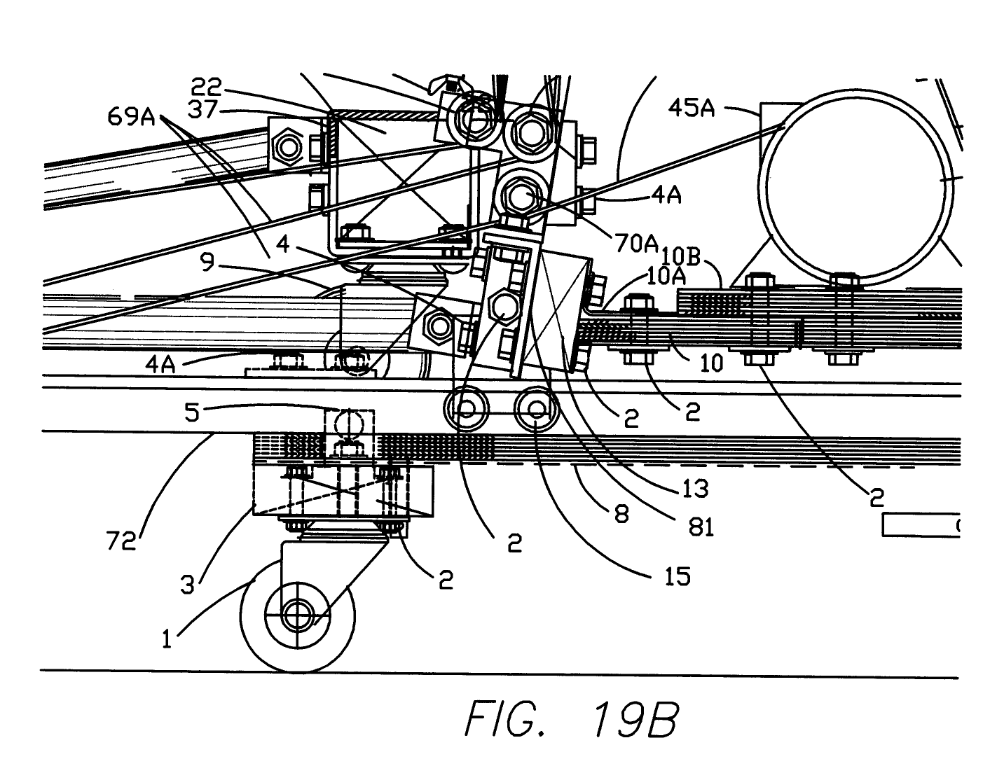

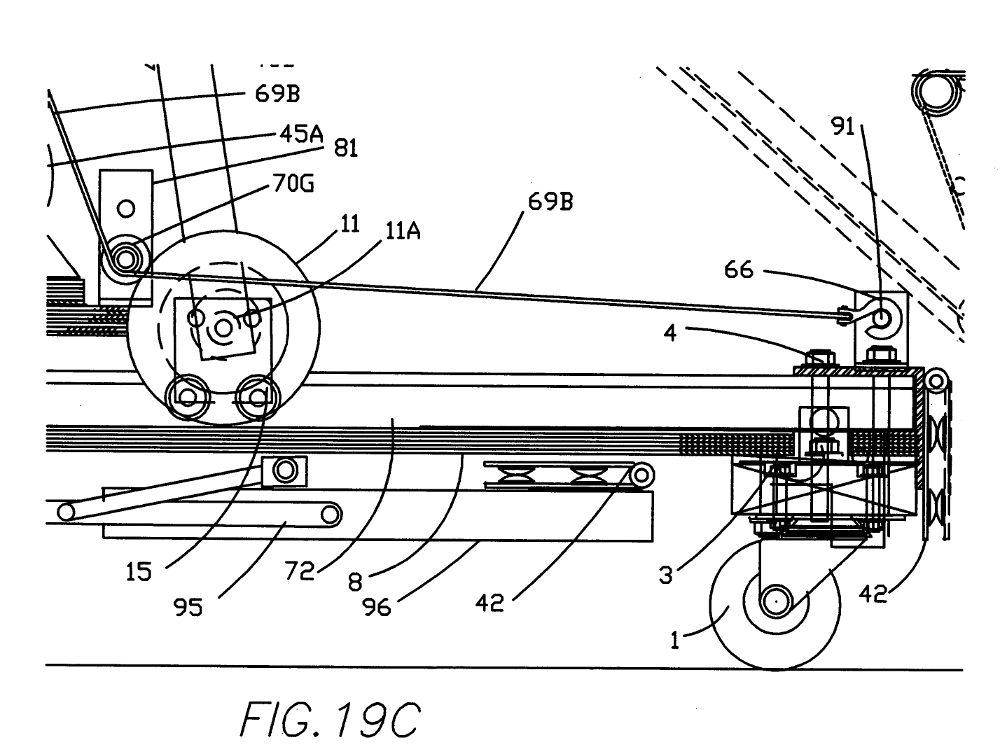

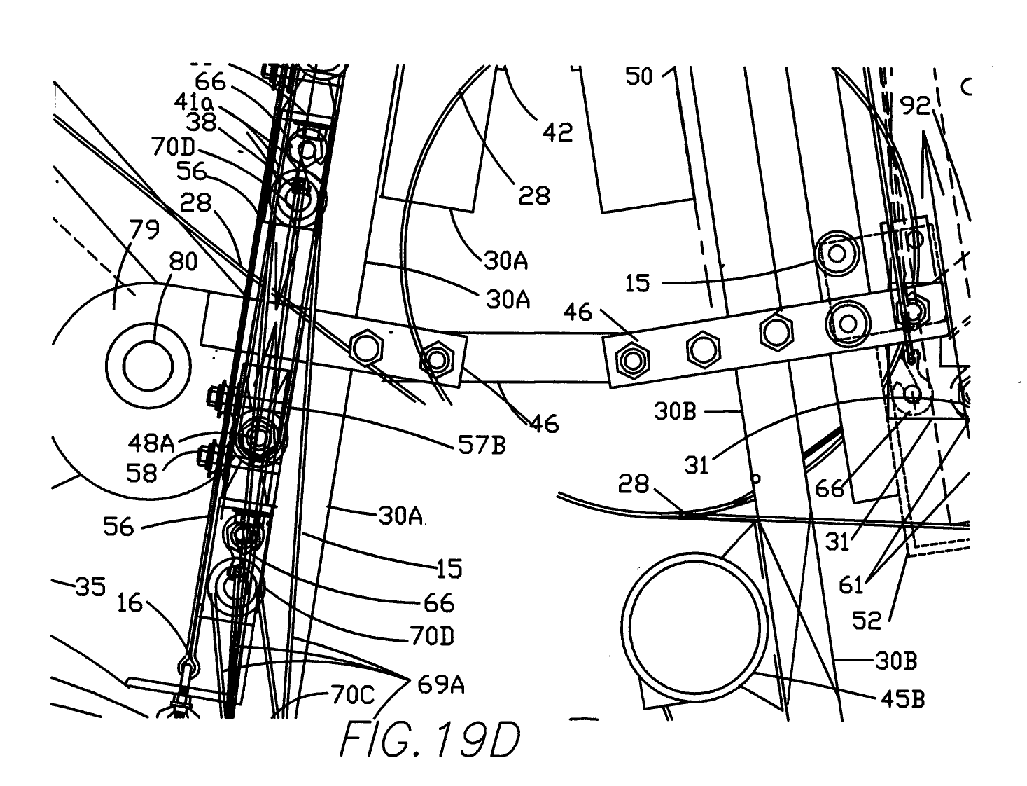

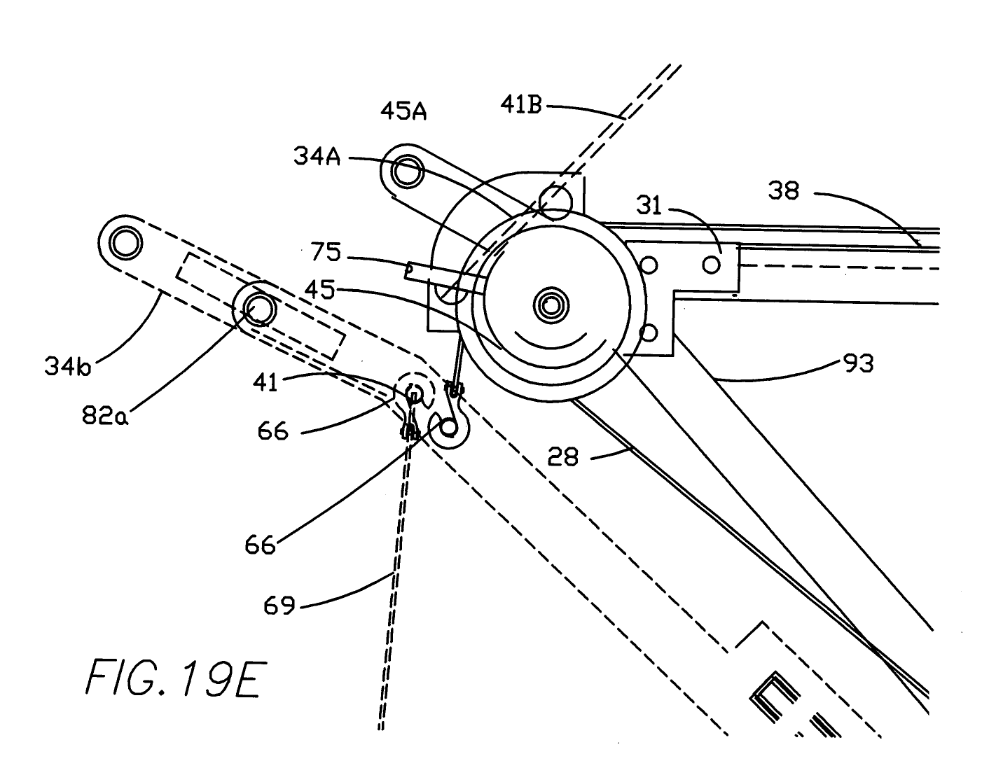

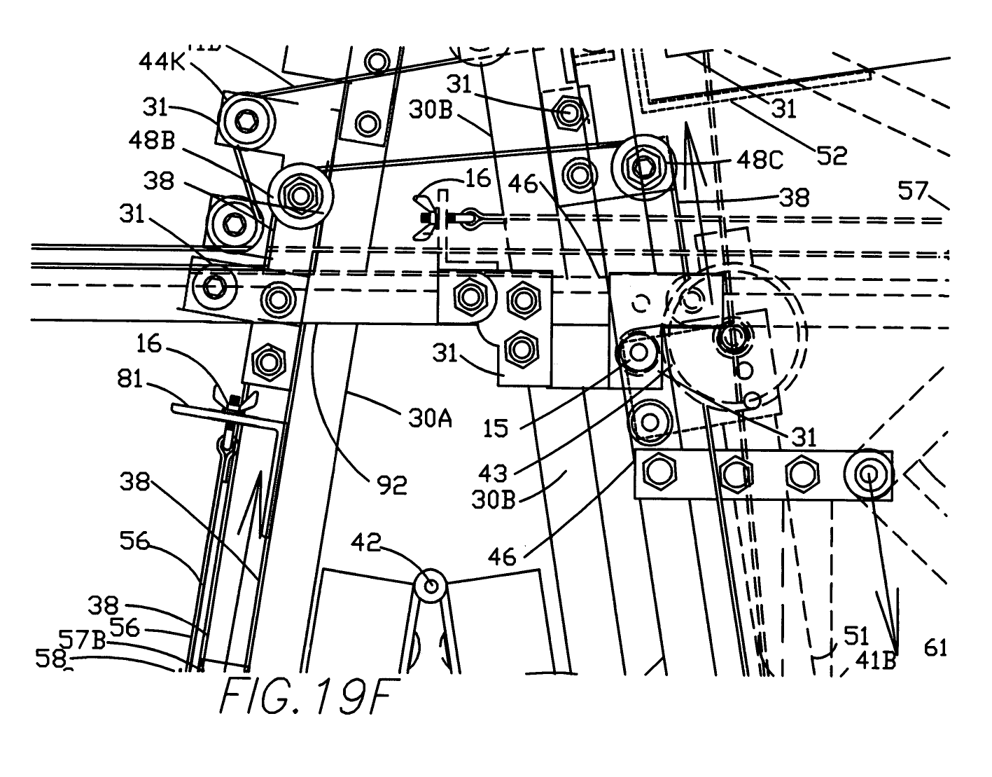

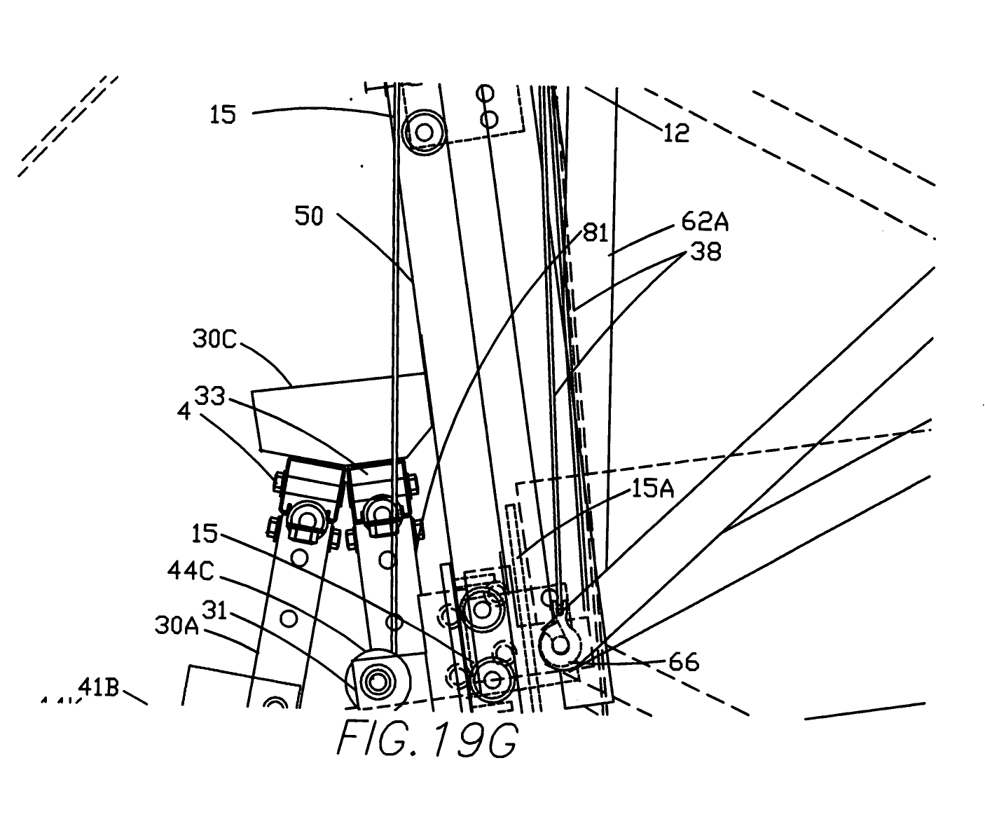

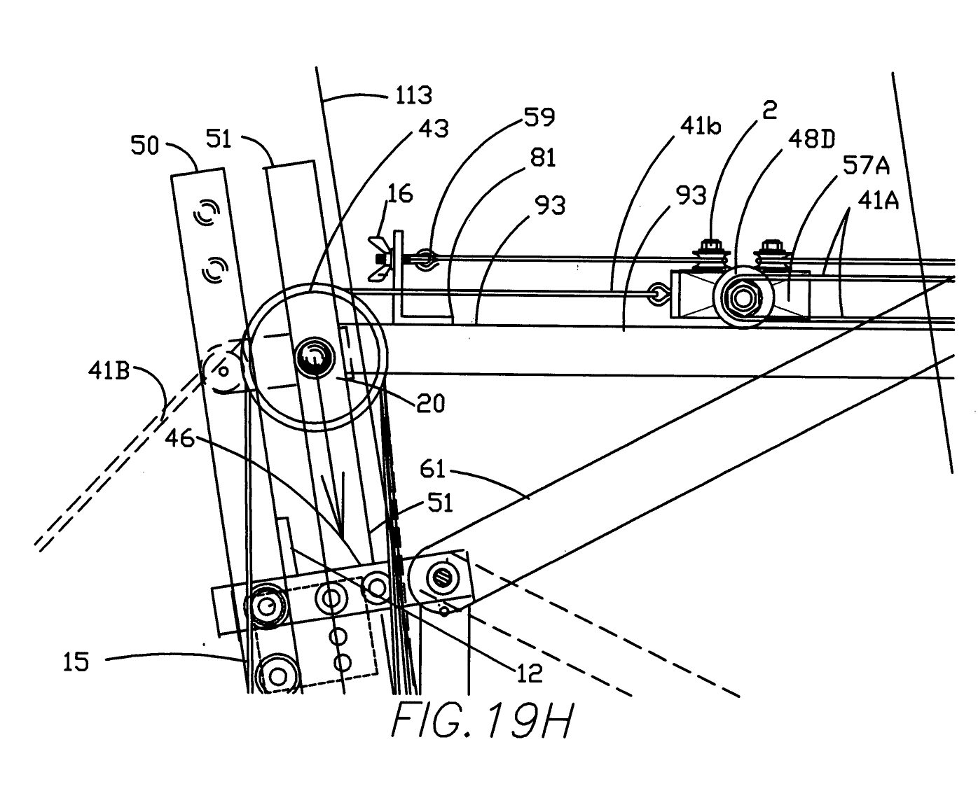

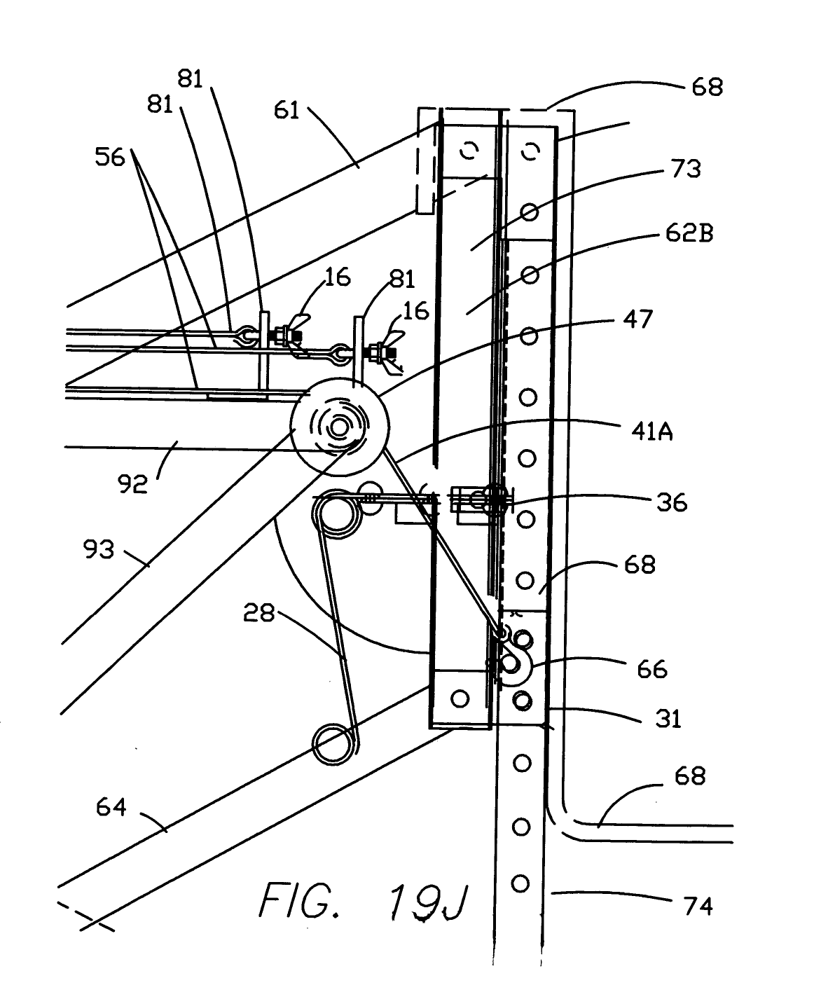

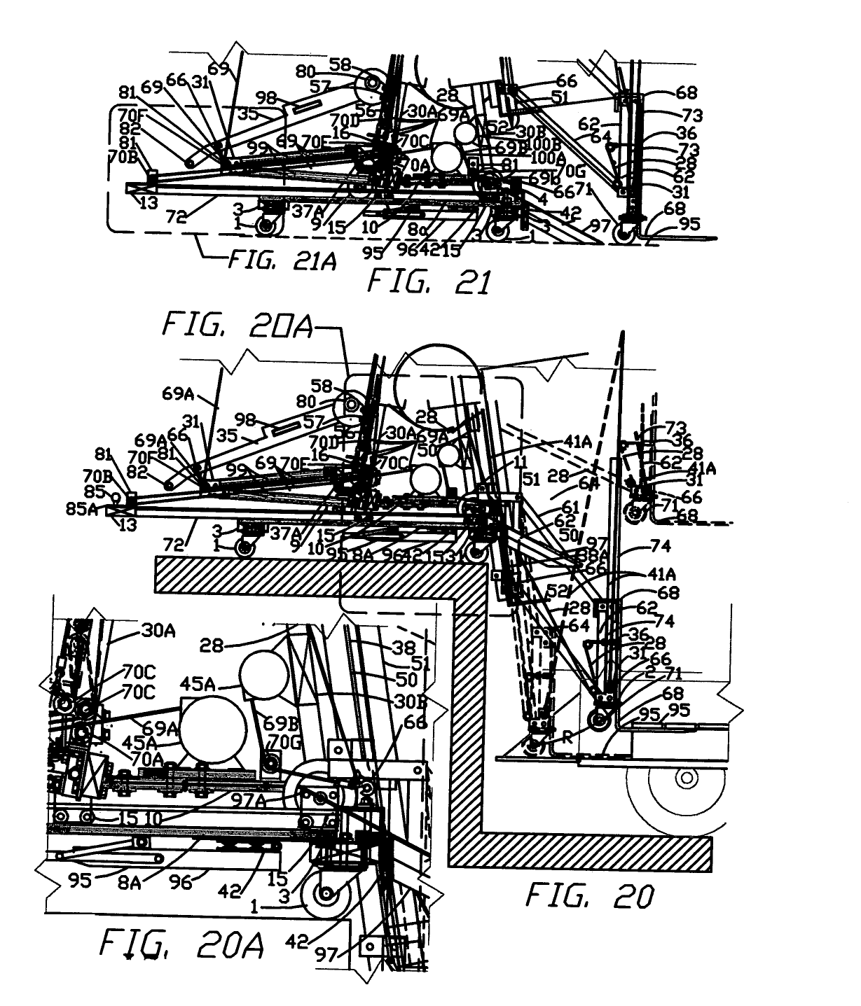

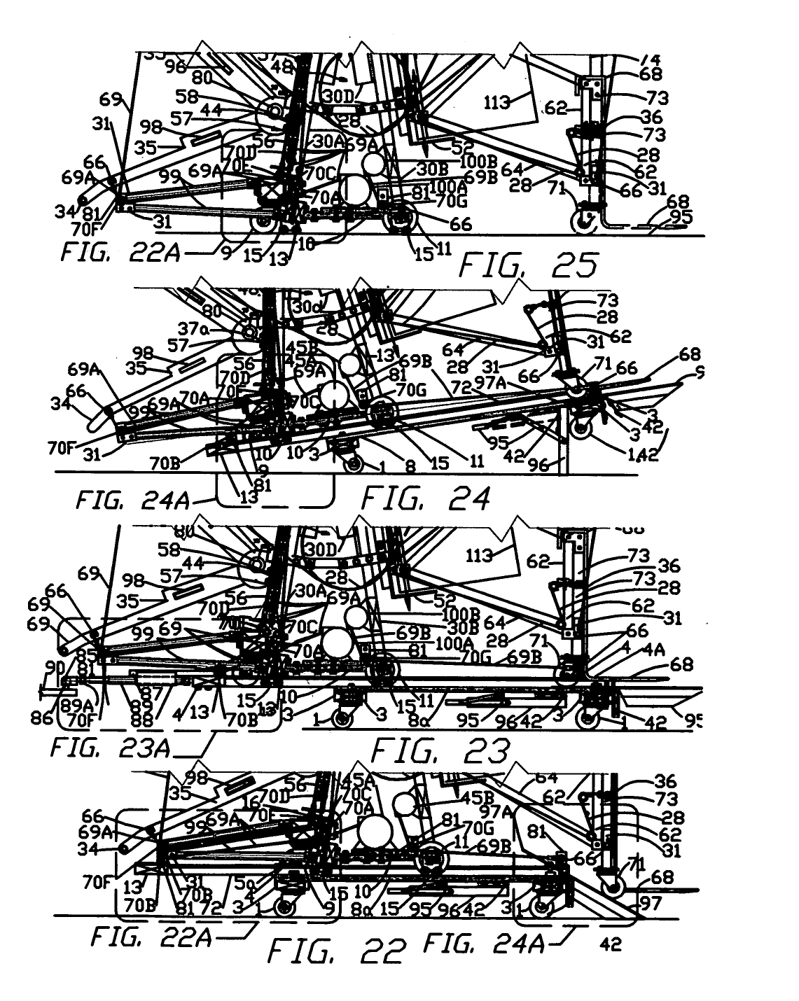

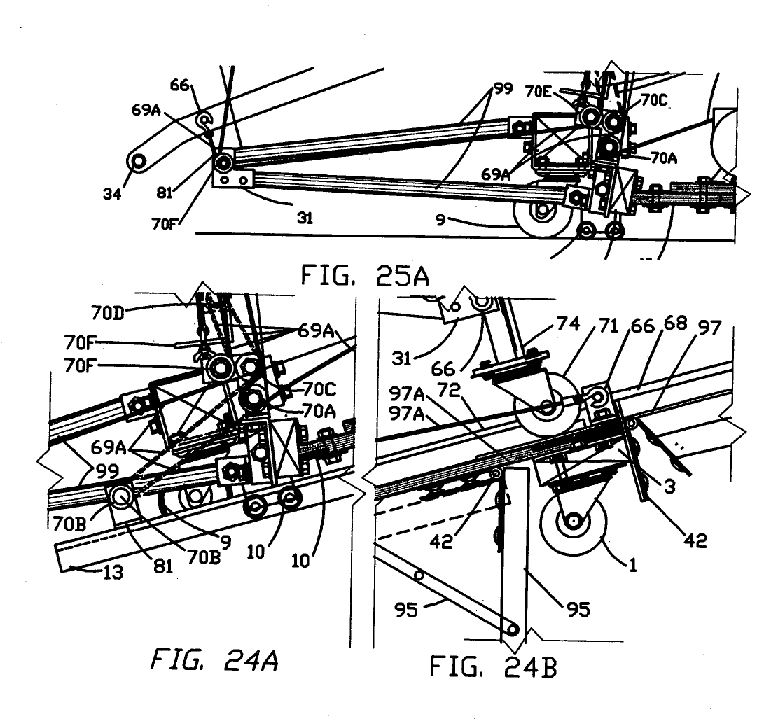

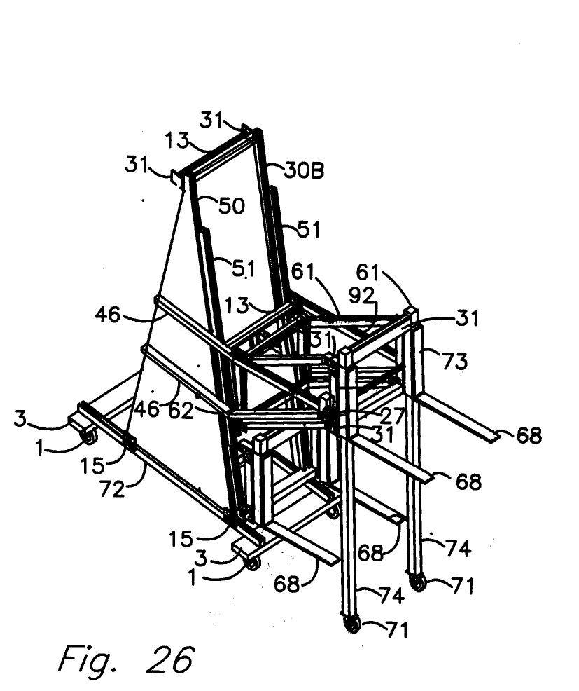

FIG. 16 illustrates the plan view cut above the cable prop frame of the balanced cable and parallel bar assemblies on the A-frame lift trolley assembly with the sleeved cable & pin assemblies, sleeved posts on wheels, lever arm, extensible mast, electric hoist and electric winch safety and power actuating devices.

FIG. 16A illustrates an enlargement of upper rear A-frame connection with channel trolleys, cable and parallel bar as referenced in FIG. 16.

FIG. 16B illustrates an enlargement of upper front A-frame connection with channel trolleys, cable and parallel bar as referenced in FIG. 16.

FIG. 16C illustrates an enlargement of upper front parallel arm to lift fork connection with cable as referenced in FIG. 16.

FIG. 17 illustrates the rear view of the lift apparatus mounted on the lift carriage trolley with the balanced cable operated lift assembly and the lift actuating electric hoist cable assembly.

FIG. 117A illustrates an enlargement of the hoist and cable assembly and parallel bar and cable rear frame post of the lift assembly as referenced on FIG. 17.

FIG. 117B illustrates an enlargement of the hoist and cable assembly as referenced on FIG. 17.

FIG. 18 illustrates an advanced enlarged sectional view as referenced in FIG. 17 at the electric hoist motor.

FIG. 19 illustrates a sectional elevation the side view of the lift apparatus from the central A-frame to the lift fork and an off-set sectional view of the lift apparatus from the central A-frame to the end of lever arm, cable guy frame and trolley carriage extensions with a partial view of the shock absorbent tongue.

FIG. 19A illustrates an enlarged view of the lowered lever arm at the cable guy frame connection positioned above of the rear end connecting plate of the trolley frame extension and shows the relative positions of cable and pulley wheels as positioned in this rearward A-frame setting on the carriage trolley.

FIG. 19B illustrates an enlarged view of the relative hoist cable and pulley wheel arrangements on metal brackets on the connecting plate between rear A-frame posts, and shows the relative positions of the lift trolley and carriage trolley wheels as-well-as cable guy and hoist motor on folding panel in this rearward A-frame setting on the carriage trolley. See the following enlargements:

FIG. 19C illustrates an enlarged view of the electric hoist motor mounted on the connecting plate of the A-frame post with front pulley and cable routing in this rearward A-frame setting on the carriage trolley. The folding trolley leg post is also shown in this view.

FIG. 19D illustrates an enlarged view of lower mid height connecting plates and hinges of the A-frame assembly at the sleeved post pin cable loop with the lift hook on the traveling front frame mounted extensible mast and the corresponding rear frame traveling parallel bar and cable positioned near the fixed pivot plate of the lever arm.

FIG. 19E illustrates an enlarged view of the rear handle positions relative to the rear prop frame connection at the rearmost pulley wheel with chains.

FIG. 19F illustrates an enlarged view of the upper A-frame connection featuring central connections of the prop frame, and A-frame connections, pulley wheel and cable arrangements.

FIG. 19G illustrates an enlarged view of the Apex connections of the A-frame showing the base of the raised front prop frame and parallel arm connections on the extensible mast.

FIG. 19H illustrates an enlarged view of the upper extensible mast connections at prop frame parallel arm and cable and pulley wheel arrangements.

FIG. 19J illustrates an enlarged view at the prop frame, parallel arm to lift fork and cable and pulley wheel arrangements.

FIG. 20 illustrates a partial side view of the front end of the lift carriage pulled to the front edge of a loading dock and the front end of the front wheel of the lift carriage at the front edge of the lift carriage with the extensible mast positioned to lift a load on raised pallet from the bed of a pickup truck.

FIG. 20A illustrates an enlarged view of the relative hoist cable and pulley wheel arrangements on metal brackets on the connecting plate between rear A-frame posts, and shows the relative positions of the lift trolley wheels rolled the front end of the lift carriage and carriage wheels rolled toward the edge of the dock as-well-as the electric winch and hoist motors on folding panel in this forward A-frame setting on the carriage trolley. The winch with cable pulls the lift apparatus to the edge of the carriage. See FIG. 20.

FIG. 21 illustrates a partial side view of the base lift apparatus on the mobile carriage with lift fork on the same floor level as the base carriage, as the lift apparatus is still in the most forward position on the carriage trolley.

FIG. 21A illustrates an enlarged view of the pulley on the rear extension of the lift carriage positioned left of the lowered lever arm handle as the lever arm is in its most forward on the trolley carriage. The sleeved post wheel supporting the lift fork as shown in this position is on the floor at the ramp connected to the carriage trolley as referenced in FIG. 21.

FIG. 22 illustrates a partial view of the of the lift trolley pulled rearward on the lift trolley to the point at which the front frame post is centered about the front and rear wheels of the carriage trolley for maximum load distribution and the wheel of the sleeved post-supporting the load fork is on the ramp which is connected to the carriage trolley as similarly shown in FIG. 19 without the ramp.

FIG. 22A illustrates an enlarged view of the pulley on the rear extension of the lift carriage positioned above the lowered lever arm handle as the lift trolley is pulled rearward on the trolley carriage as referenced in FIG. 22.

FIG. 22B illustrates a partial view of the of the lift trolley pulled rearward on the lift trolley to the point at which the wheel of the sleeved post supporting the load fork is on the ramp which is connected to the carriage trolley as referenced in FIG. 22.

FIG. 23 Illustrates the lift apparatus on the carriage pulled to the most rearward position on the trolley carriage prior to tilting of the lift apparatus and the lift carriage to dismount the lift carriage.

FIG. 23A illustrates a partial view of the lowered lever arm with hoist cable and hook at the cable guy frame and the rearmost pulley wheel near the associated pulley wheels mounted on the connecting plate of the rear frame of the lift apparatus prior to disconnecting the continuous hoist cable from this rearmost pulley wheel prior to dismounting the carriage trolley as referenced in FIG. 23.

FIG. 24 illustrates a partial side view of the lift apparatus on the mobile carriage in an inclined position with leg unfolded for dismounting the carriage with the aid of the electric winch remotely operated by the operator or the use of a switch on an extension chord at the lever handle. The pulley wheel mounted on the carriage trolley is now removed to release the release the continuous hoist cable such that the trolley carriage can be clearly dismounted and separated entirely from the lift trolley.

FIG. 25 illustrates a partial view of the dismounted A-frame lift trolley totally disconnected from carriage.

FIG. 26 illustrates a 3-dimensional view of the lift apparatus on a lift carriage with wheels added as similarly shown without the cable guy, rear cable prop frame, pivoting ramp nor lever arm assemblies, but with a parallel frame and the optional attachment of the lift fork directly mounted on the extensible mast. This mode of assembly is equipped with the electric hoist and winch with cables which are mostly covered with side panels.

### DETAILED DISCRIPTION OF THE INVENTION

The manually operated lift apparatus with cogwheels and an optional rear mounted hydraulic jack assembly is first described below with occasional reference to the preferred optional electric hoist motor and balanced cable system which is introduced in this continuing CIP application:

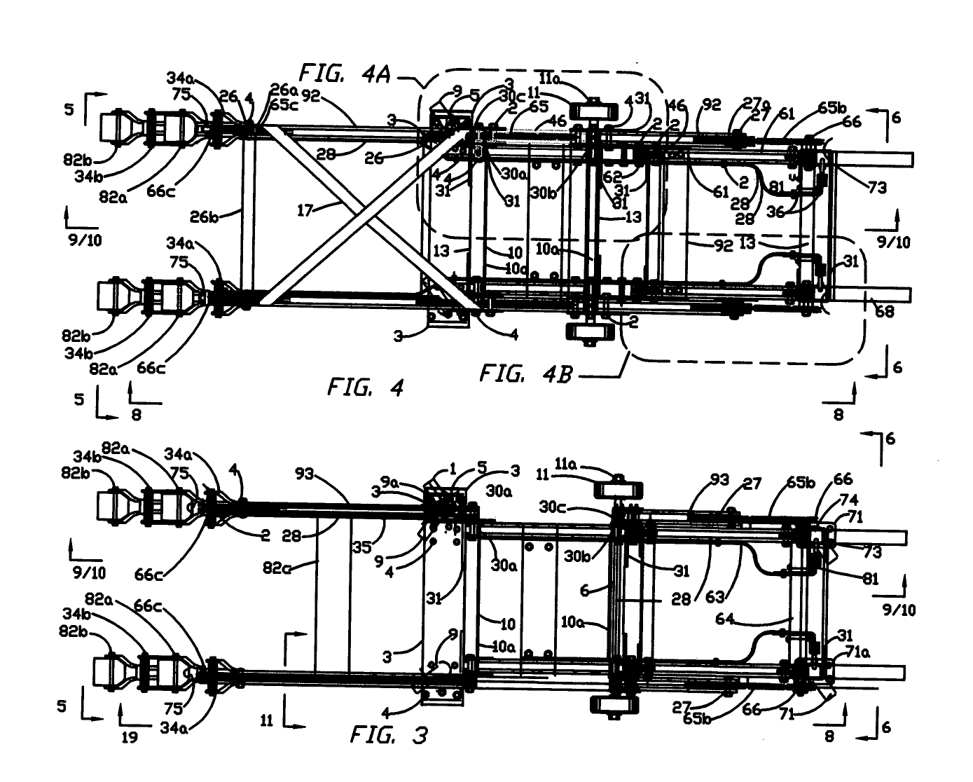

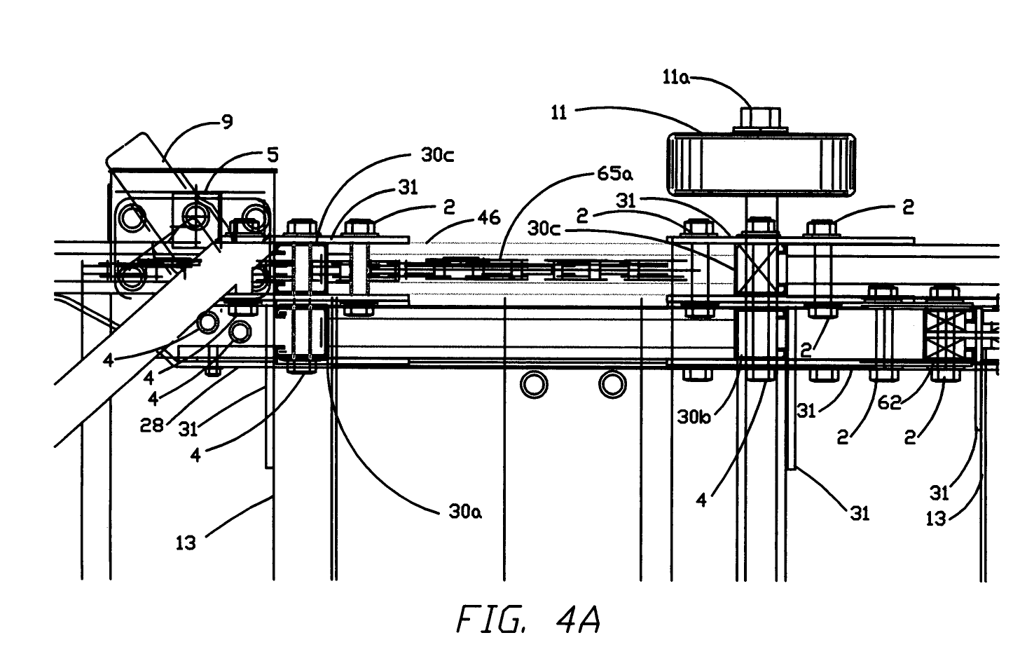

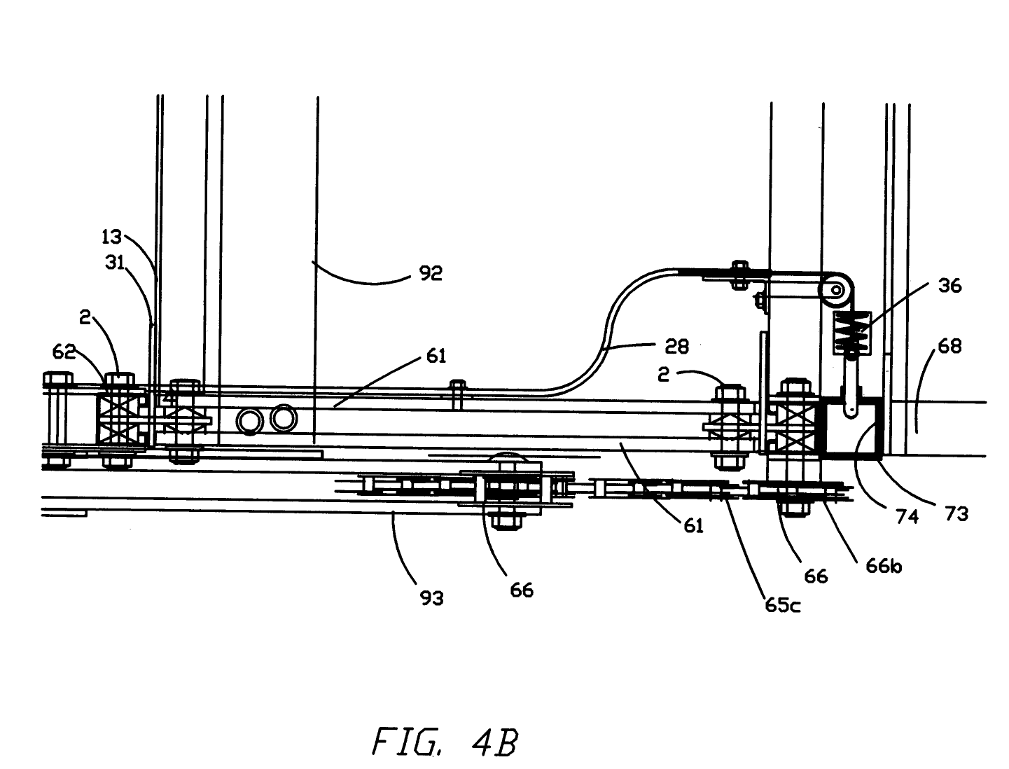

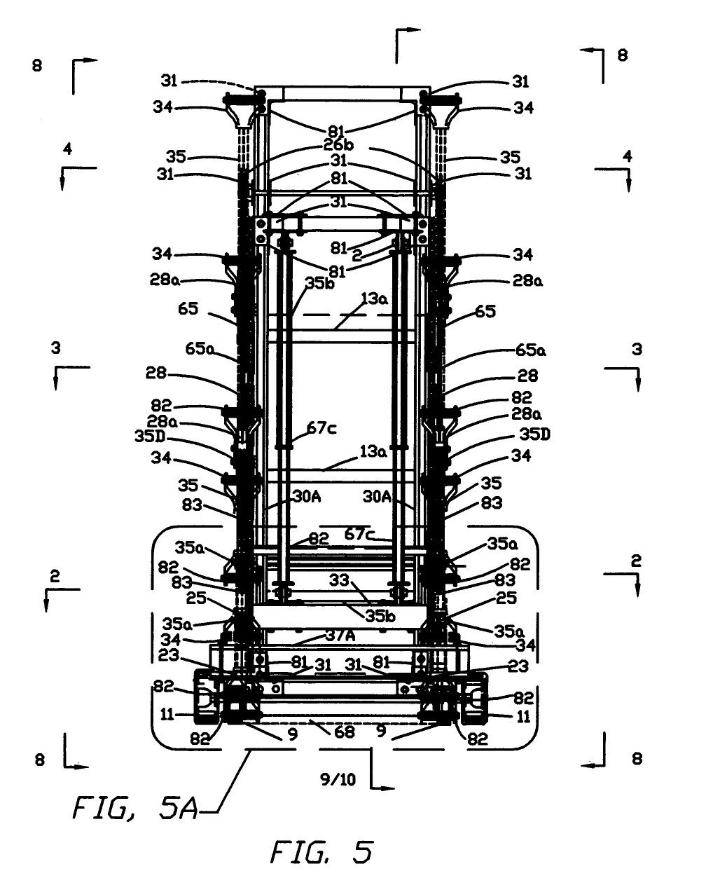

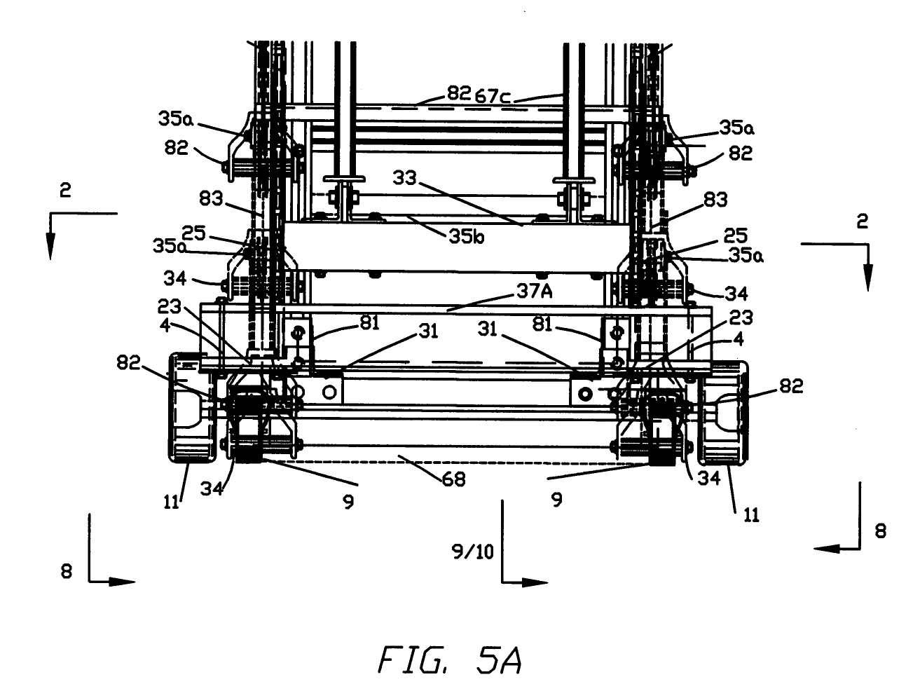

The lift is positioned to receive a load on fork 68 which is directly attached to a tubular sleeved support post assembly by means of corner angles 31, 81 and 91 which connects it to a mast 51 which is connected to the front posts of the A-frame base assembly by means of these mounting brackets when assembled for manual operation by use of levers as illustrated in FIGS. 3, 4, 9 and 10.

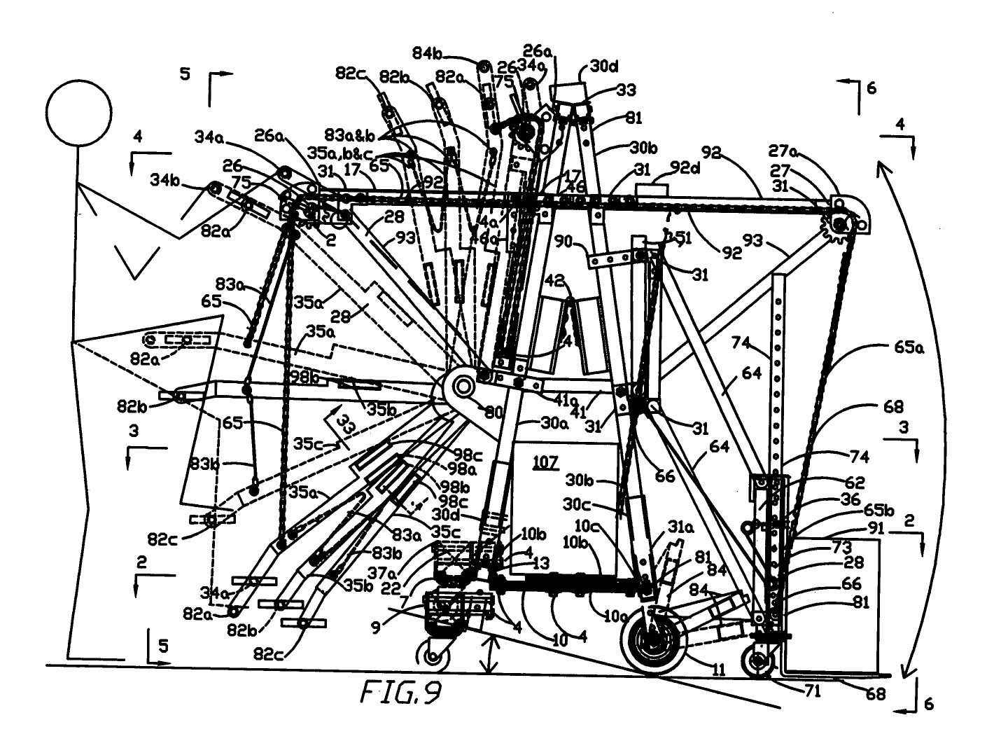

The present invention is further improved by the preferred use of a rear mounted balanced cable assembly actuated by an electric hoist and cable assembly, or by the optional means of a pair of power operated hydraulic jacks 67c to lift or lower the front mounted extensible mast 51 to which both the bulky 113 load is directly attached and preferably to which the rotary mast frame 61,62,63 and 64 is attached as illustrated in FIGS. 5,11,12,13 and 14 and further illustrated in FIGS. 16,17 and 19 the connection to the longer lift chains 65a than that of a lift assembly which is not equipped with an extensible mast. The rear mounted jack assembly is used to lift the front mounted extensible mast by means cogwheel with optional rear mounted jacks. The chains runs from rear mounted jack assembly 67c /67d across the top of the A-frame on cogwheels 25, 26C and 27C to point at the base of extensible mast 51 to lift chain hook 66. When the rear mounted jack is extended the extensible mast chain 65a is offset about cogwheel 25 causing the resultant lifting of the extensible mast 51 and the connected rotary mast frame as described herein. The longer chain 65a is hooked 66 at a higher position on the frame post 30a relative to the depth of the lowered position of the extensible mast 51 when the mast is raised and set for lifting loads as shown in FIGS. 8 and 9 as well as FIG. 12,13 and 14.

The multiple hand and foot operated levers 35 and the chain prop assemblies 92/93 are folded into vertical position so-as-to assume less space when moving and turning in tight spaces, or when stored as illustrated in FIGS. 8 and 9. L-shaped pins are inserted in the outermost holes on the rotary segments of bar 46 to hold the levers and mast prop assemblies in the folded position about the base frame of the lift.

When the manually operated levers 35 are rotated using chain assembly 65 about cogwheels 26 and 27 on chain prop frame 92/93 the load fork 68 is lifted accordingly. The lowering of lever handles 34 is achieved by stepping on foot pedal 82 which is suspended from lever 35 at handle 34 by means of an adjustably flexible cable 83 and buttress by channel 98a, and vice-versa for lowering the foot pedal about pivot 80, FIGS. 9 and 10, 12,13 and 14.

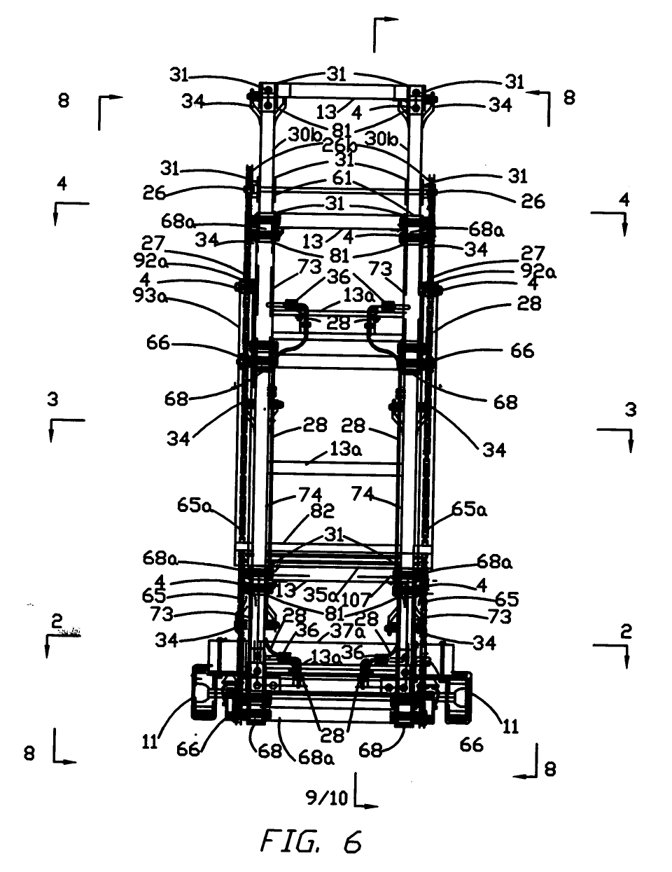

A retractable pin assembly 36 as best illustrated in FIG. 13F is used to hold the raised rotary mast frame 62 at selected locked heights on mast props 74 when required. The retractable pin assembly 36 is a spring-loaded assembly that engages in slotted holes in sleeved mast frame assembly 73 which sleeves vertically along rotary mast props 74 mounted atop casters 71, FIGS. 1,3,8,9 and 10. The mast prop assembly is locked at a selected height when the holes in metal tubes 73 and 74 are aligned with the engaging pin assembly which is mounted to the top of rotary lift frame cross tie 13 of the lift assembly as illustrated in FIG. 3. The pins must be retracted before the rotary mast assembly is allowed to be lowered. The sleeved mast tubes 74 must be lifted slightly to free the retractable pins. The spring-loaded pins are operated by means of a manually operated cable assembly 28 connected to control handle 75 mounted lever handle 34 at the rear connection of chain prop assembly 92/93 as best shown in FIG. 13D. See FIGS. 3, 6 and 8 and enlarged view 13F for location of this cable/pin assembly. The spring loaded pins extend to lock the sleeved posts in place when lever controls on cables are released at handles and is therefore a safety measure for assuring that the load is secured on the post frame if the levers are released inadvertently. This assembly is illustrated in FIGS. 3,4,8 and 9.

When the extensible lift mast 51 is raised by means of the rear mounted jack and chain assembly 67c or 67d as best shown in FIGS. 5, 13B and 13D to elevate the inner pivotal height of the rotary mast 62 and the corresponding manual parallel repositioning of the lift chain hooks 66 from points at the upper ends of lift frame posts 30a to points on pivoting lever arms 35 is done the sleeved post assembly, 73 an 74, is raised accordingly when the rotary mast (61,62,63 and 64) is rotated upward again by means of the lever and chain assembly as best shown in FIGS. 12, 13 and 14. The sleeved post 74 is preferably held to the sleeved tube 73 by use of the spring-loaded pin and cable assembly 28/36. If and when the sleeved posts 74 require removal or replacement this achieved by the aid of another person holding the sleeved posts 74 during this operation. The load on the lift fork 68 at this extended height cannot be secured by the sleeved post assembly unless taller sleeved posts 74 of adequate length are used and are sleeved within tubular sleeve 73. The raising and lowering of this rotary mast (61,62,63 and 64) with the sleeved post 74 attached is illustrated in FIGS. 5, 12,13 and 14.

The manually operated lever chain 65 starts at a point on lever 35 at handle 34 and runs across rear cogwheels 26 along chain prop frame 92/93 to front cogwheel 27 to a hook 66 at base of fork and tongue assembly 62/68 as illustrated in FIGS. 3,4,8,9 and 10. The rotation of the levers controls the lifting of load fork 68. The chain assembly is secured about the cogwheels by means of an assembly of axles and wheel covers 26a and 26b. The chain prop assembly 92/93 is braced by means of plates 17 and 92d and is framed by metal channels 92 and 93. Like the longer chain 65a which is used when the extended mast 51 is lowered to pick up loads from a lower platform the lift chain 65 is hooked at a more distant, but lower position on the lever arm 35 relative to the depth of the lowered position of the lift fork 68 on the rotary mast post 62 when the rotary mast (61,62,63,64) is raised for lifting loads as shown in FIGS. 8 and 9 as well as the raised mast positions shown in FIGS. 12 and 14.

The center-of-gravity of the load on this forklift may be shifted to the center of the optionally attached base carriage by manually moving the lift apparatus on trolley wheels 15 along metal channel tracks 72 mounted on the base carriage assembly to the position similarly shown in FIG. 22. Roller wheels 9 and 11 are used to move the forklift assembly on hard and smooth surfaces when the lift assembly is not mounted atop the mobile base carriage assembly described herein. The load may also be pivoted as illustrated in FIGS. 9,10 and 14 to shift the center of gravity of the load. The wheels and base panels are connected by means of bolts 2, 4 and 4a.

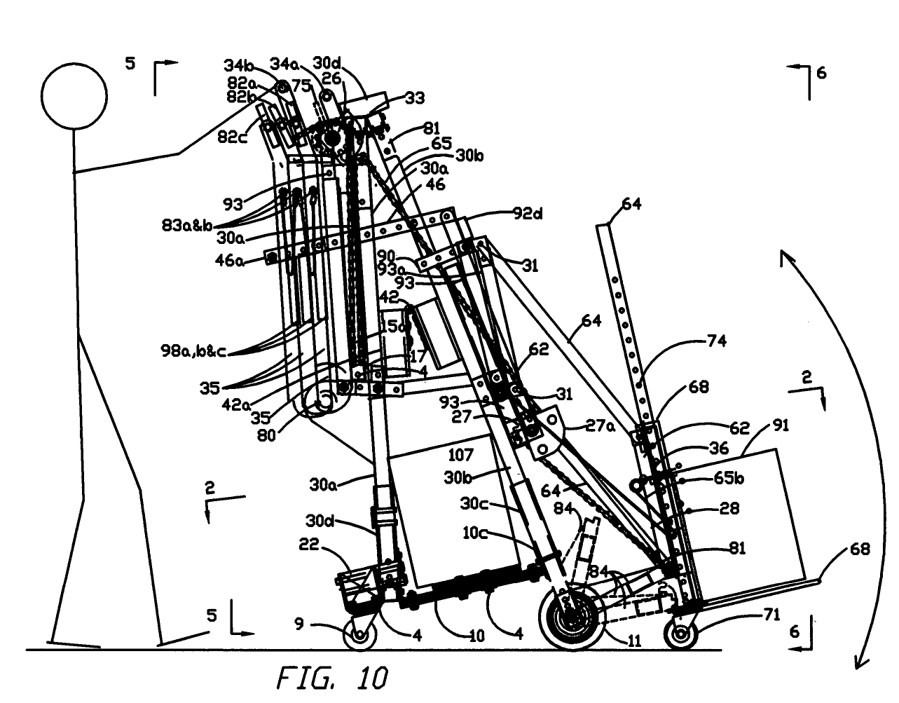

The base frame assembly may be set up as a cubicle or a-frame assembly channels 30c and 30d by means of hinges 42 and straps 10c attached to the lower base frame connecting assembly 10 as illustrated in FIGS. 1,2,8,9 and 10. The base may also be folded when the unit is in the transport or storage mode as illustrated in FIG. 10 so-as-to take up less space. The pivotal central assembly frame connector bars 41,41a, 46 and 46a are detached at one end to allow the A-frame to fold and reconnected with rods to hold the folded frame assembly in place as illustrated in FIG. 10.

The post channels of the lift frame assembly 30a/30b are mounted on the mobile base platform assembly comprised of metal channels 8a, 72, panel 10 and cross ties 3 on both ends by means of trolley wheels 15 that roll along inside metal channel 72 as best shown in FIGS. 1, 3, 11, 12, 13, and 14. This platform assembly is mounted on axle connecting front wheels 11 on axle 11a and rear mounted swivel wheels 1 for rolling light loads such as those carried on hand trucks. The various plate and channel connectors 5,3,6,7,13,23,24,31,37,80,90,91,92 and 93 which hold the lift frame together are secured by various lengths of bolts 2, 4 and 4a as shown throughout the drawings for this invention.

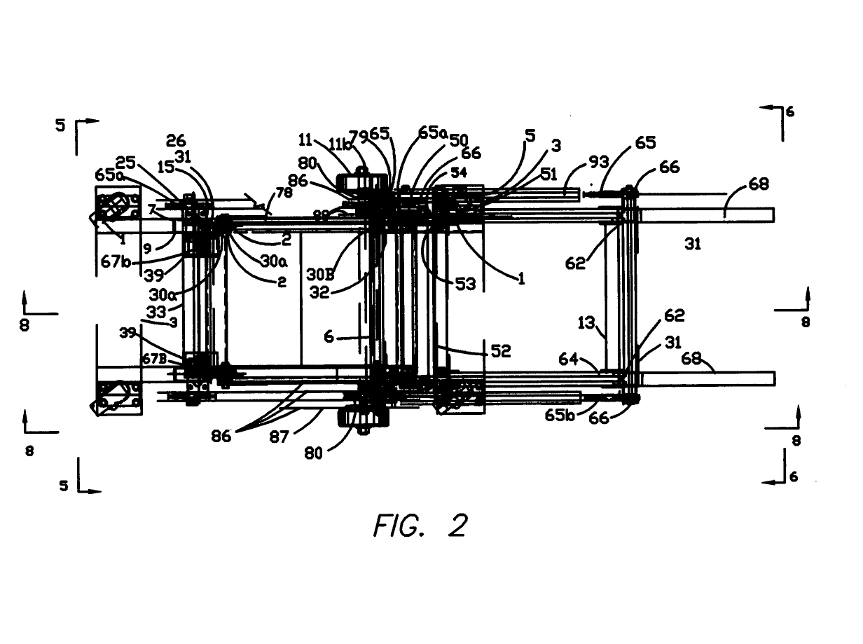

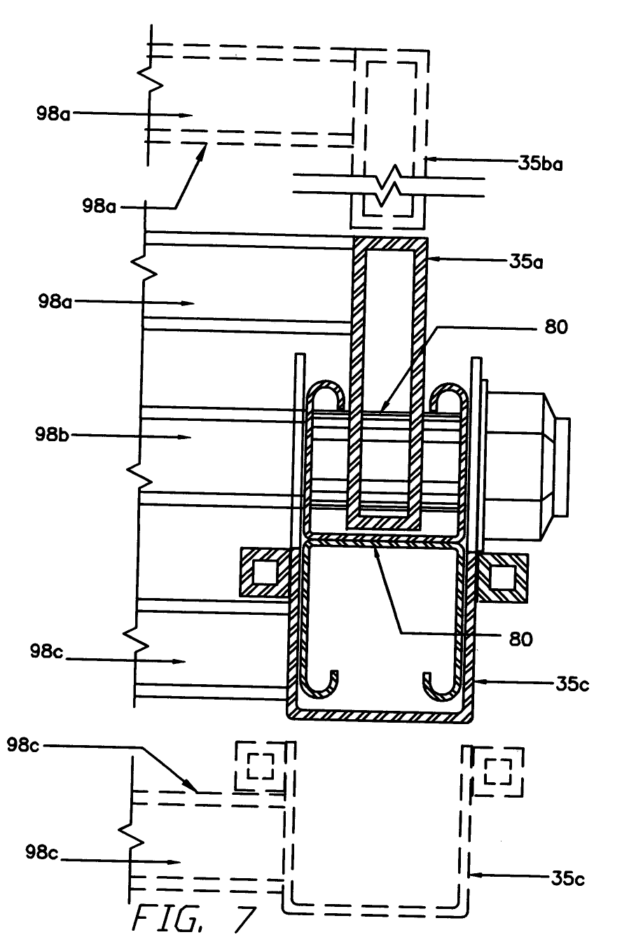

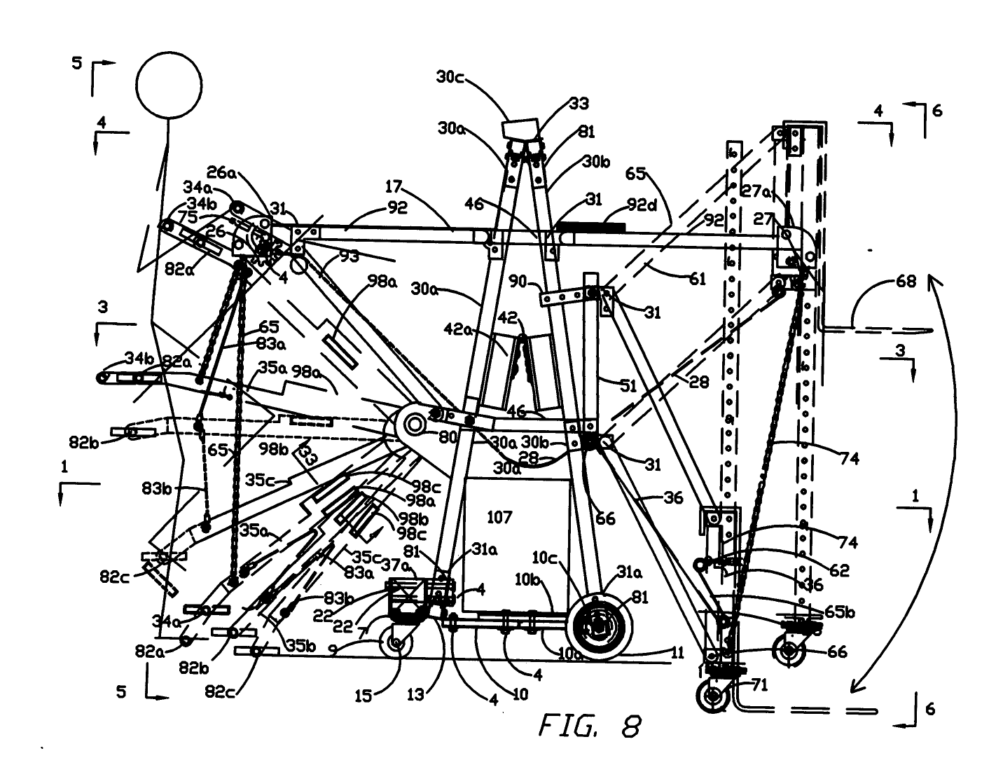

The present lift trolley as described in the earlier version of this continuing application is retained in the present application as described above and illustrated in the attached drawings FIG. 1 through FIG. 14 is comprised of a basic folding A-frame assembly with the basic operating features which consist of a load fork 68 attached to a sleeved frame 73 at the outer vertical frame lifting 62 of a parallel arm (rotary frame) which moves vertically about a pair of sleeved posts 74 on swivel wheels 71. The parallel arm alternately has trolley connections 15 at a post 51 which enable it to travel vertically as the extensible mast 51 along a track 50 connected to the basic A-frame assembly at the front frame 30b for maximum vertical lifting range, or to the rear vertical posts 51 to which the rotary arm is connected are attached directly to the front frame posts 30A of basic lift assembly for a limited lift height range of approximately four feet. The basic A-frame assembly is equipped with rotating fan of levers 35A, 35B and 35c which are used to manual actuate lifting of the load fork 68 on the parallel arm post 62 by means of a pair of chains 65 extending across cogwheels 26 and 27 on propped frame assemblies 92/93 by the use of handles 34 and pedals 82 at the outer ends of the lever arms 35. These lever arms 35 may alternately lift the extensible masts 51 on the front of the basic A-frame mounted post 50 along which the lift fork 68 would then travel vertically to achieve lifting.

The present invention is further improved to function as a non-power actuated trolley where-in an electric hoist 45A with cable 69A and hook 66 is used as a primary means to actuate the three functions of mounting of the lift fork 68 onto a carriage trolley, shifting the lift fork on the carriage trolley and actuating the lift masts of the lift trolley as illustrated in a side elevation in FIG. 19, a rear view in FIG. 17, a plan view in FIG. 16 and in sequential views of mounting and dismounting the lift carriage trolley in FIG. 20 through FIG. 25. The electric hoist 68 is used to lift the load fork 68 systematically and automatically in three successive stages with an electric hoist 45A with cable 69A having a hook 66 attached to a cable 69A looped about a series of pulley wheels on metal mounting brackets 81A starting at pulley F70 at the base panel 8 of the lift carriage, as best shown in FIG. 19B to a second pulley 70B at bracket 81B at the rear extended frame connecting panel 13 of the lift carriage, as best shown in FIG. 19A back to a third pulley 70C on the upper part of the bracket 81A of the first wheel to a fourth pulley 70D at the bottom center of the parallel bar 57B mounted on the rear channel track posts 30A of the A-frame assembly with trolleys 15, as best shown in FIG. 19D and back to a fifth wheel 70E mounted on an offset bracket 31 attached to the upper bracket 81B of the second and third pulley wheels, out to a sixth pulley wheel 70F mounted at the end of a triangular frame 99, as best shown in FIG. 19A, with four legs which are attached to the base legs of the lift frame and from there to up to ring 86 at the central vertex of a cable 29 suspended from two lever arms 35 with a connecting bar 33 at the outer end near the lever arm handles 34 to which the hoist cable 69A is hooked as best shown in FIG. 19E. The cable is run in such an arrangement that when an actuating force of pulling is exerted on the hoist cable 69A the sequence shifting and lifting of the lift trolley components begins based on the lesser resistance of the various components to movement. First the wheels 71 of the pair of sleeved posts assemblies 74 & 73 which supports the lift fork 68 which is attached to the outer vertical frame 62 of the parallel arm 35 to ascend the pivotal ramps 97 which are mounted to the ends of the carriage trolley frame as best illustrated in FIGS. 22 & 23. The A-frame lift trolley with the lift fork 68 and sleeved posts 74 indirectly attached then rolls rearward along the tracks 72 of the trolley carriage on wheels 15. As the wheels 71 of the sleeved post move rearward they suppress the upper metal plate extensions 97A of the pivotal ramps 97 to raise hold the ramps clear of the floor as best shown in FIG. 23. When this rearward motion is stopped by removable plates 5 with pins 4A on the channel tracks 72 of the carriage trolley the pulling force on the hoist cable 69A transfers to the second stage of limited movement in which the extensible mast is actuated by the force on the balanced parallel bar 57B and the pair of cables 38 looped about pulley 48A at the ends of the bar as best illustrated in FIGS. 19D and 17B. One end of the looped cable 38 is terminated at a bolt 91 or ring 86 on a bracket on the rear A-frame posts 30A of the lift assembly near pulley wheel 48B other end extends to a hook 66 at the base of the optionally used extensible mast 51 as best illustrated in FIGS. 19D & 19F. The load fork 68 is also optionally connected to the extensible mast 51 by means of trolley wheels 15 which enables the loaded lift fork 113/68 to travel vertical along the mast 51 at a 2 to 1 ratio when lifted by means of the force on the balanced cable assembly 38 which loops about pulley 60 at the top of the extensible mast as best shown in FIG. 19. The force exerted by the electric hoist 45A on the extensible mast 51 raises the mast to a fixed or a manually selected height by use of fixed plates 12 on the channel of the rear A-frame or by use of double pronged pin extensions 15B which are manually set in holes on the punched channel tracks 30A. The lifting of the extensible mast 51 will also result in the lifting of the parallel arm simultaneously in a vertical manner at the rear along the tracks of the channel tracks on which the trolley wheels of the extensible mast posts 51 to which the parallel arm is attached travel. When the rear end of the parallel arm is raised to its highest point the extensible mast to which it is connected the trolley wheels will also stop and the force exerted on the lift cable 69A is transferred from the previous point of exertion at pulley 70d down to and under an offset pulley 70E mounted to the outer end of a metal corner plate 3 Ion metal bracket 81A and from there out to and under pulley 70F mounted on the connecting metal plate 31 of cable guy frame 99 and up to a ring 91 at the central vertex of a suspended cable 29 connecting parallel arms 35 by means of hook no 66 is now transferred to the parallel lift arms 35 which ultimately results in further lifting of the load fork 68 in a pivotal manner. As the force is exerted on the pair of lever handles 35 the cables 41B which extend up and over pulley wheel 26A along the propped cable horizontal frame 92 to and under pulley 44A up to 44B across to pulley 44c and up to pulley 60 as best shown in FIGS. 19E, F, G and H and from there out to terminate at eye bolts 16 connected to the parallel bar 57A as best shown in FIG. 17B which travels along the elevating horizontal propped frame 92 as best shown in FIG. 17B which is mounted to the front extensible mast 51. With the extensible mast 51 having been raised in the previous second stage the parallel arm post 62B to which the lift fork 68 is attached is raised at twice pace of the extensible mast because of the looped cable arrangements of the balanced cables 41A about pulley wheels 48D which actuate lifting of a load fork 68. The pair of balanced cables 4 1A extend from pulley wheels 48D to and over pulleys 27 at the outer end of the propped cable assembly 92/93 and down to ring 86 or pin 91 at the base of sleeved post frame 74 to which the lift fork 68 is attached as best shown in FIG. 19J. When the double pronged pins 15A as best shown in FIG. 19G are engaged in the holes of the punched tracks of the channels 50 mounted to the front A-frame posts 30A of the lift assembly to stop the trolley wheels 15 at rear parallel arm post 51 at a select height the lifting force on the parallel arm 62B at the sleeve post 73 holding the lift fork 68 will cause pivotal upward rotation of the lift fork about the parallel arm. This upward rotation will occur until the upper frame 61 of the parallel arm reaches the under side 93 of the elevating propped frame assembly directly above it. With the double pronged pins 15A engaged the subsequent lifting of the lift fork 68 will occur as the resultant force on cable 69A is transferred to the lever arms 35 which will ultimately actuate the lifting of the load fork as explained above.

The mounting of the trolley carriage with legs 96 unfolded to set with metal leg braces 95 in an inclined position is achieved when an electric winch 45B mounted to a horizontal plate 13 on the front posts 30B of the lift trolley with a cable 69A extending down to and under the front pulley wheel 70G at the front of the folding base panel 8 of the A-frame lift trolley with a hook 66 to a ring 86 or pin 91 mounted at the front end of the lift carriage is set to actuate a pulling motion as shown in elevation in FIG. 25, The A-frame lift trolley with trolley wheels 15 aligned at the center of the tracks 72 of the tilted lift carriage will ascend the tracks to various positions as shown in plan in FIG. 16 and in elevation in FIGS. 20 through 23. When the front trolley wheels 15 and rear trolley wheels 15 of the A-frame are equally spaced about the rear wheels 1 of the lift carriage trolley the legs 96 of the tilted lift carriage are folded up such that the lift carriage can be lowered to a level plane with relative ease. This allows continued movement of the lift trolley toward the front of the carriage trolley in a manner that enabled the A-frame lift trolley to mount the carriage trolley from the rear to subsequently cause the wheels 71 of the sleeved posts 74 of the lift fork 68 to move forward dismount the carriage by means of the hinged ramps 97 on the front of the carriage trolley as best shown in FIG. 25,

The lift carriage trolley is equipped with a shock absorbent tongue assembly as best shown in Figs which comprises a standard medium to heavy duty shock absorber 89 bolted to the under side of steel tube tongue extension 87 which is bolted to a wood cross tie plate 13 of the trolley carriage frame extension. The shock absorber 89 is sleeved by a steel channel 88 which welded to the steel tube tongue extension 87 such that it will prevent pivotal movement of the shock absorber. The telescopic smaller end of the shack absorber 89 is bolted to the metal trailer hitch ball cover 85 with two bolts to stabilize the front end of the shock absorber the metal hitch ball cover is mounted on the hitch ball 86 which is mounted on the hitch extension of a Motorized tug cart (not shown).

In the event of a loss of sufficient electrical power for operating the power actuated lift apparatus a substituting chain of levers as disclosed in the earlier application and maintained in the present application for use on a manually operated lift apparatus is adaptable for use on the power operated lift until such time that sufficient power can be restored to operate the lift assembly. The rotating chain of pairs of levers 35B, and 35C as best illustrated in FIGS. 1,3,4,5,8,9,10 12, 13 and 14 are mounted temporarily to the pair lever arms 35 which becomes 35A in the series to act in the manner described above for the manually operated lifting apparatus.

### BACKGROUND OF INVENTION

1. Field of Invention

The present application is a non-provisional continuation-in-part to previous non-provisional application Ser. No. 09/788,019 filed Feb. 20, 2001 that pertains to manually operated Lifting Trolleys with a preferred option of using a power operated electric hoist when used to supplement lifting operations and transporting loads for short distances having weight comparable to the lift operator's body weight under any spatial condition and lifting light commercial and industrial loads in enclosed spaces with a maximum live load design of 100 pounds per square foot. The basic assembly of the simplest mode of the present lift apparatus lifts a load from the floor to at least the various heights to delivery trucks and work beaches and the more complex assembly with electric motors and extensible mast(s) lifts a loads to heights comparable to those of conventional masts with extensible masts, and provides a means of lifting such loads in spaces which are not accessible to conventional power operated lifts where the use of such lifts are restricted because they are either too heavy or too wide, and in some cases environmentally restricted and on floors where use of motorized lifts with brake systems are prohibited by building codes for design reasons having to do with lateral forces. In some cases it is not economically feasible to have multiple or a power operated forklifts for such light loads. The lift trolley of the present invention is new and useful as one which is used to lower the extensible mast for lifting loads from a surface lower than that on which the lift trolley sets. The extensible mast is lowered and raised to a preferred setting height preferably by means of a rear mounted electrically operated hoist and chain or a balanced cable assembly. This lift trolley as disclosed in the original application is adaptable to the conventional application a power operated hydraulic jack and chain or balanced cable assembly only when the lift is used in a well vented or outdoor location.

The present invention was conceived as a mobile load handling retractable assembly with an attached rotary mast which was discovered as a result of designing a means of lifting an assembly of hinged connected floor-to-wall-to roof panels for an improvement in U.S. Pat. No. 3,857,211

2. Description of Related Art

In regard to previous inventions the Lifting Trolley, U.S. Pat. No. 5,681,139, which is primarily used to lift such loads racks of bread in a bakery is actuated functions by use of the hand held lever principally in the same manner as the present invention accept that it only has only one lever frame lift as opposed to a radial on-folding pivotal assembly of levers which are connected to each at their outer end by means of flexible cables. The lift trolley also feature spring loaded frame latch assemblies which engage to lock the load in at desired heights.

FIG. 16C illustrates an enlargement of upper front parallel arm to lift fork connection with cable as referenced in FIG. 16.

FIG. 17 illustrates the rear view of the lift apparatus mounted on the lift carriage trolley with the balanced cable operated lift assembly and the lift actuating electric hoist cable assembly.

FIG. 17A illustrates an enlargement of the hoist and cable assembly and parallel bar and cable rear frame post of the lift assembly as referenced on FIG. 17.

FIG. 17B illustrates an enlargement of the hoist and cable assembly as referenced on FIG. 17.

FIG. 18 illustrates an advanced enlarged sectional view as referenced in FIG. 17 at the electric hoist motor.

FIG. 19 illustrates a sectional elevation the side view of the lift apparatus from the central A-frame to the lift fork and an off-set sectional view of the lift apparatus from the central A-frame to the end of lever arm, cable guy frame and trolley carriage extensions with a partial view of the shock absorbent tongue.

FIG. 19A illustrates an enlarged view of the lowered lever arm at the cable guy frame connection positioned above of the rear end connecting plate of the trolley frame extension and shows the relative positions of cable and pulley wheels as positioned in this rearward A-frame setting on the carriage trolley.

FIG. 19B illustrates an enlarged view of the relative hoist cable and pulley wheel arrangements on metal brackets on the connecting plate between rear A-frame posts, and shows the relative positions of the lift trolley and carriage trolley wheels as-well-as cable guy and hoist motor on folding panel in this rearward A-frame setting on the carriage trolley. See the following enlargements:

FIG. 19C illustrates an enlarged view of the electric hoist motor mounted on the connecting plate of the A-frame post with front pulley and cable routing in this rearward A-frame setting on the carriage trolley. The folding trolley leg post is also shown in this view.

FIG. 19D illustrates an enlarged view of lower mid height connecting plates and hinges of the A-frame assembly at the sleeved post pin cable loop with the lift hook on the traveling front frame mounted extensible mast and the corresponding rear frame traveling parallel bar and cable positioned near the fixed pivot plate of the lever arm.

FIG. 19E illustrates an enlarged view of the rear handle positions relative to the rear prop frame connection at the rearmost pulley wheel with chains.

FIG. 19F illustrates an enlarged view of the upper A-frame connection featuring central connections of the prop frame, and A-frame connections, pulley wheel and cable arrangements.

FIG. 19G illustrates an enlarged view of the Apex connections of the A-frame showing the base of the raised front prop frame and parallel arm connections on the extensible mast.

FIG. 19H illustrates an enlarged view of the upper extensible mast connections at prop frame parallel arm and cable and pulley wheel arrangements.

FIG. 19J illustrates an enlarged view at the prop frame, parallel arm to lift fork and cable and pulley wheel arrangements.

when the rotary mast (61,62,63,64) is raised for lifting loads as shown in FIGS. 8 and 9 as well as the raised mast positions shown in FIGS. 12 and 14.

The center-of-gravity of the load on this forklift may be shifted to the center of the optionally attached base carriage by manually moving the lift apparatus on trolley wheels 15 along metal channel tracks 72 mounted on the base carriage assembly to the position similarly shown in FIG. 22a. Roller wheels 9 and 11 are used to move the forklift assembly on hard and smooth surfaces when the lift assembly is not mounted atop the mobile base carriage assembly described herein. The load may also be pivoted as illustrated in FIGS. 9,10 and 14 to shift the center of gravity of the load. The wheels and base panels are connected by means of bolts 2, 4 and 4a.

The base frame assembly may be set up as a cubicle or a-frame assembly channels 30c and 30d by means of hinges 42 and straps 10c attached to the lower base frame connecting assembly 10 as illustrated in FIGS. 1,2,8,9 and 10. The base may also be folded when the unit is in the transport or storage mode as illustrated in FIG. 10 so-as-to take up less space. The pivotal central assembly frame connector bars 41,41a, 46 and 46a are detached at one end to allow the A-frame to fold and reconnected with rods to hold the folded frame assembly in place as illustrated in FIG. 10.

The post channels of the lift frame assembly 30a/30b are mounted on the mobile base platform assembly comprised of metal channels 8a, 72, panel 10 and cross ties 3 on both ends by means of trolley wheels 15 that roll along inside metal channel 72 as best shown in FIGS. 1, 3, 11, 12, 13, and 14. This platform assembly is mounted on axle connecting front wheels 11 on axle 11a and rear mounted swivel wheels 1 for rolling light loads such as those carried on hand trucks. The various plate and channel connectors 5,3,6,7,13,23,24,31,37,80,90,91,92 and 93 which hold the lift frame together are secured by various lengths of bolts 2, 4 and 4a as shown throughout the drawings for this invention.

The multipurpose electric hoist motor with cable and hook, the balanced parallel bar cable assemblies and the adverse acting electric winch with cable and hook are introduced in this continuing CIP application to operate the present lift trolley assembly is described below:

The present lift trolley as described in the earlier version of this continuing application is retained in the present application as described above and illustrated in the attached drawings FIG. 1 through FIG. 14 is comprised of a basic folding A-frame assembly with the basic operating features which consist of a load fork 68 attached to a sleeved frame 73 at the outer vertical frame lifting 62 of a parallel arm (rotary frame) which moves vertically about a pair of sleeved posts 74 on swivel wheels 71. The parallel arm alternately has trolley connections 15 at a post 51 which enable it to travel vertically as the extensible mast 51 along a track 50 connected to the basic A-frame assembly at the front frame 30b for maximum vertical lifting range, or to the rear vertical posts 51 to which the rotary arm is connected are attached directly to the front frame posts 30A of basic lift assembly for a limited lift height range of approximately four feet. The basic A-frame assembly is equipped with rotating fan of levers 35A, 35B and 35c which are used to manually actuate lifting of the load fork 68 on the parallel arm post 62 by means of a pair of chains 65 extending across cogwheels 26 and 27on propped frame assemblies 92/93 by the use of handles 34 and pedals 82 at the outer ends of the lever arms 35. These lever arms 35 may alternately lift the extensible masts 51 on the front of the basic A-frame mounted post 50 along which the lift fork 68 would then travel vertically to achieve lifting.

The present invention is further improved to function as a non-power actuated trolley where-in an electric hoist 45A with cable 69A and hook 66 is used as a primary means to actuate the three functions of mounting of the lift fork 68 onto a carriage trolley, shifting the lift fork on the carriage trolley and actuating the lift masts of the lift trolley as illustrated in a side elevation in FIG. 19, a rear view in FIG. 17, a plan view in FIG. 16 and in sequential views of mounting and dismounting the lift carriage trolley in FIGS. 20 through FIG. 25. The electric hoist 68 is used to lift the load fork 68 systematically and automatically in three successive stages with an electric hoist 45A with cable 69A having a hook 66 attached to a cable 69A looped about a series of pulley wheels on metal mounting brackets 81A starting at pulley F70 at the base panel 8 of the lift carriage, as best shown in FIG. 19B to a second pulley 70B at bracket 81B at the rear extended frame connecting panel 13 of the lift carriage, as best shown in FIG. 19A back to a third pulley 70C on the upper part of the bracket 81A of the first wheel to a fourth pulley 70D at the bottom center of the parallel bar 57B mounted on the rear channel track posts 30A of the A-frame assembly with trolleys 15, as best shown in FIG. 19D and back to a fifth wheel 70E mounted on an offset bracket 31 attached to the upper bracket 81B of the second and third pulley wheels, out to a sixth pulley wheel 70F mounted at the end of a triangular frame 99, as best shown in FIG. 19A, with four legs which are attached to the base legs of the lift frame and from there to up to ring 86 at the central vertex of a cable 29 suspended from two lever arms 35 with a connecting bar 33 at the outer end near the lever arm handles 34 to which the hoist cable 69A is hooked as best shown in FIG. 19E. The cable is run in such an arrangement that when an actuating force of pulling is exerted on the hoist cable 69A the sequence shifting and lifting of the lift trolley components begins based on the lesser resistance of the various components to movement. First the wheels 71 of the pair of sleeved posts assemblies 74 & 73 which supports the lift fork 68 which is attached to the outer vertical frame 62 of the parallel arm 35 to ascend the pivotal ramps 97 which are mounted to the ends of the carriage trolley frame as best illustrated in FIG. 22b. The A-frame lift trolley with the lift fork 68 and sleeved posts 74 indirectly attached then rolls rearward along the tracks 72 of the trolley carriage on wheels 15. As the wheels 71 of the sleeved post move rearward they suppress the upper metal plate extensions 97A of the pivotal ramps 97 to raise hold the ramps clear of the floor as best shown in FIG. 22b. When this rearward motion is stopped by removable plates 5 with pins 4A on the channel tracks 72 of the carriage trolley the pulling force on the hoist cable 69A transfers to the second stage of limited movement in which the extensible mast is actuated by the force on the balanced parallel bar 57B and the pair of cables 38 looped about pulley 48A at the ends of the bar as best illustrated in FIGS. 19D and 17B. One end of the looped cable 38 is terminated at a bolt 91 or ring 86 on a bracket on the rear A-frame posts 30A of the lift assembly near pulley wheel 48B other end extends to a hook 66 at the base of the optionally used extensible mast 51 as best illustrated in FIGS. 19D &

What I claim is:

1. A lifting trolley comprising:
A comprehensive improvement in a lifting trolley comprising a combination of basic components which include a folding A-frame on wheels supporting a rear frame mounted assembly of interconnected successive activating lever arms with handles and pedals connected to a front frame mounted parallel lift arm by means of a pair of chains which run across cogwheels respectively mounted at the outer top intersection of separate pairs of the frames with a rear mounted triangular prop frames affixed to the rear frame posts and a front frame optionally mounted in a fixed manner to the front frame posts of the basic A-frame or on track mounted trolleys which travel vertically along the front frame or a multiple trolley connected series of extensible mast channels, and having a lift fork attached to the outer rotating vertical members of the front of the parallel arm which is lifted along sleeved punched posts with engaging spring loaded pins which are controlled manually from the rear lever handles by means of the cables all such that when the rear levers are pushed downward the chain assemblies pull the parallel frame upward on a one-to-one ratio or a two-to-one ratio or more when the extensible mast(s) with offsetting cogwheels which is separately actuated by means of a pair of chains preferably connected to a rear frame mounted electric hoist and cable assembly or an optional hydraulic jack assembly which actuate pulling the chains across front and rear mounted wheels mounted at the top of the A-frame assembly which lifts the extensible masts vertically along the front frame channel tracks and the optionally mounted additional masts to achieve variable lifting heights and settings at swift pace, and with ease and assurance that the raised load will not accidentally fall to the floor;

2. a lifting trolley in claim 1 wherein an A frame lift trolley is mounted on a lift carriage with permanently affixed wheels being adaptable to be optionally mounted and dismounted from the base carriage trolley with a shock absorbent tongue to lessen the resultant impact on floors with suspended structural frames when the breaks of the tug vehicle pulling the loaded carriage are applied, and a pair of tracks for trolley wheels and an optional pair of front mounted pivoting ramps which would enable displacement of the without the preferred sleeved post assembly;

3. a lifting trolley in claim 1 wherein the absence of sufficient electrical power or an in-operable motor a lift trolley with a rotating chain of levers is mounted to the rear frame posts of the A-frame assembly with interconnecting cables at lift handles and interchangeably used foot pedals with a pair of chains running up and across cogwheels on an axle connecting the outer upper ends of two rear post frame mounted chain prop frames and with chains running across to cogwheels mounted on the outer upper frame of a pair of front mounted chain prop frames and down to a hook mounted on the outer base corner connection of the pivoting front parallel arm mast which is fixed or mounted to travel along the front channel posts of the A-frame apparatus in such a manner as to offset wheels to maintain maximum operable chain length;

4. an improvement in lifting trolley in claim 1 where-in a chain of levers are pivoted about a central point on the lifts rear frame and connected by means of cables on the outer ends at the connected lift pedals so-as-to actuate lifting of the front mounted trolley mast by means of a pair chains which run across cogwheels at the outer connections of the rear mounted chain prop assembly and across balanced cogwheels placed at the inner connection of the chain prop assembly so-as-to align vertically above the hook pins on the mast and pull the load which travels vertically along the a-frame channel track in the same manner as the extensible mast with a load attached load attached;

5. a lifting trolley in claim 1 where-in a sleeved cable with manual control levers extend from the rear handles the of the lift apparatus to the front outer posts of the rotary frame to spring loaded pins which engage the sleeved post supports so-as-to allow the load on the lift fork to be positioned at select heights and avoid tilt-over and provide a safety mechanism when the control lever is released, and where-in the spring loaded pins are engaged to hold the sleeved post intact when the sleeved posts are elevated beyond their reach when the rotary frame is extended to a height that lifts the posts clear of the floor,

6. a lifting trolley in claim 1 of a chain prop assembly with chain off-setting cogwheels where-in pairs of front and rear triangular arrangements chain prop frame assemblies with cogwheels aligned wit linear centerline of the frames at the upper outer connection on common axles, and chains extend from connection at the lever arms on the rear handle up and over the rear cogwheels to and under aligned offsetting cogwheels at upper A-frame connections near the extensible mast up to and over an aligned pair of cogwheels mounted at fixed points on the upper part of the extensible mast and down to hooks at the base of the lift fork optionally connected to the extensible mast by means of interlocking trolleys, or when the optional parallel frame is used run alternately under a second pair of chain offsetting cogwheel on a common axle and longitudinally aligned near the extensible mast on the inner horizontal connection of the vertically extensible frontal prop frames to and over cogwheels at the outer upper connections of the frontal extensible chain prop frames and down to hooks at the base of the outer parallel arm assemblies to lift the lift fork when a downward force is applied to the rear mounted pivoting lever arms at ratios of 1-to-1 or multiples of 2-to-1 relative to the number of extensible masts with offsetting cogwheels used;

7. a lifting trolley in claim 1 where-in a folding base frame panel connection with end strap connection and a central strap connection are used to allow the horizontally positioned panel to fold at the top of panel end connections onto the a-frame posts while the panel folds correspondingly upward at the central bottom strap connection to result in a folded trolley for the lift trolley in storage and transport modes and requires less space occupation when not in use;

8. an improvement in a lifting trolley in claim 1 wherein a shock absorbent carriage tongue is used to reduce the resultant impact on floors supported by a suspended frame which are not normally designed with consideration for the higher live load requirements for floors of which motorized lift vehicles with break systems are permitted to be used; thereby permitting use of a motorized lift apparatus pulled by a motorized tug to used be used on upper floors of more buildings to lifting and haul heavy loads for increased material handling in such spaces as stock rooms, print shops and spaces used for light manufacturing by securing one end of the shock absorber to the cross member of the lift carriage with a fixed sleeve to allow longitudinal movement, but prevent lateral movement;

9. an improvement in a lift trolley in claim 1 wherein a metal ramps with a heavy gage metal plates are mounted to the front base of the lift carriage with hinges such that when the swivel wheels of the sleeved posts are pulled up the ramp onto the floor of the lift carriage trolley to achieve load distribution on avoid tilt-over the wheel press the angular plates down and elevates the ramp mobility of the lift carriage;

10. an improvement in a lifting trolley wherein a balanced lift cable system which would most often be in more readily available supply as a replacement in some states for the preferred chain means of lifting with the substitution of pulley wheels for cogwheels as described in claims 1, 3 and 4 and the addition of a single or series of parallel bar and cable assemblies to which the lift cable is looped as termination points or about which the lift cable is preferably looped in a continuous run to provide greater take-up when this cable is actuated by means of an electric hoist mounted on the connecting base panel of the A-frame assembly with the cable hook of the hoist attached to the bottom center of the parallel bar assembly with one wheel each at the vertical center of the outer ends of the bars about which the cable is looped to provide greater take-up in lift cable;

11. an improvement in a lift trolley in claim 10 where the standard form of the once commonly used parallel bar with 4 pulley wheels with a transverse cable assembly which terminates at eye bolts at each cable ends to allow for tensional adjustments, and the bar is modified with the addition of side mounted bolts for cable termination or with wheels of the pulley type for a looped cable system or cogwheels to achieve a balanced parallel lift actuating bar to displace the lift mast to which the pair of cables or chains are attached by way of wheels mounted to the upper fixed frame and extensible masts of the lift apparatus;

12. a comprehensive improvement in a lifting trolley where-in an electric hoist with cable and hook is used as a primary means to actuate the three functions of mounting of the lift fork onto a carriage trolley, shifting the lift fork on the carriage trolley and actuating the lift masts of the lift trolley which are used to lift the load fork systematically and automatically in three successive stages with an electric hoist having a hook attached to a cable looped about a series of pulley wheels on metal mounting brackets starting at the first pulley at the base panel of the lift carriage, to a second pulley wheel at the rear extended frame of the lift carriage, back to a third pulley wheel on the upper part of the bracket of the first wheel to a fourth pulley wheel at the bottom center of the parallel bar mounted on the rear channel track posts of the A-frame assembly with trolleys, and back to a fifth pulley wheel mounted on an offset bracket attached to the upper bracket of the second and third pulley wheels, out to a sixth pulley wheel mounted at the end of a triangular frame with four legs which are attached to the base legs of the lift frame and from there to up to ring at the central vertex of a cable suspended from two lever arms with a connecting bar at the outer end near the lever handles to which the hoist cable is hooked all in such an arrangement that when an actuating force of pulling on the hoist cable first causes the wheels of the pair of sleeved posts assemblies which supports the lift fork and is attached to the outer vertical frame of the parallel arm to ascend the pivotal ramps which are mounted to the ends of the carriage trolley frame then move rearward while suppressing the upper metal plate extensions of the pivotal ramps to raise and hold the ramps clear of the floor the and as this rearward motion is stopped at this point the pulling force on the hoist cable transfers to the second stage of limited movement in which the extensible mast is actuated by the force on the balanced parallel bar and the pair of cables looped about pulley traveling along the rear frame and up to and over pairs of pulley wheels mounted at the upper part of the A-frame and down to down to a hooks at the base of the extensible mast to actuate a lifting force on the extensible mast and to simultaneously cause lifting of the lift fork which is being pulled upward by means of the parallel arm mast which pushes the inner post 51 mounted on trolleys 15 up the tracks of channel 50 until the wheels are stopped be means of manually inserting double pronged pins in the tracks to fit above and below the trolley to stop vertical movement or to a fixed metal stop on the track and a subsequent third stage in which the resultant force on the hoist cable is transferred to the lever arms to ultimately actuate lifting of a lift fork by means of a balanced parallel bar and cable assembly running under and across pulley wheels on the cable prop frame assemblies which is mounted on swivel wheeled sleeved posts attached to the outer vertical frame of a parallel arm or directly to a preferred optional extensible mast which travels vertically along the front post frame to systematically and automatically complete the comprehensive three successive stages of movement to achieve maximum load distribution, significantly reduce the resultant impact of stopping on structurally suspended floors, avoid tilt-over, to maximize the frontal, height and depth range of the lift trolley apparatus and actuate mounting and subsequent dismounting with the use of an electric winch and cable all in succession based on the relative resistance to movement of the lift assembly components in a continuous motion with all lift trolley features mounted and by means of the optional use of cables and reverse movement of the lift trolley A-frame and the indirectly attached load fork to dismount the carriage trolley;

13. an improvement in a tilt-up lift trolley in claim 12 with folding metal leg braces such that when an electric winch mounted to a horizontal plate on the front posts of the lift trolley with a cable extending down to and under the front pulley wheel at the front of the folding base panel of the lift mast to a ring or pin mounted at the front end of the lift carriage is set in a pulling motion the A-frame lift trolley with wheels aligned at the center of the tracks of the tilted lift carriage will ascend the tracks to a selected position such that when the front and rear wheels of the A-frame are equally spaced about the rear wheels of the lift carriage trolley the legs of the tilted lift carriage are folded up such that the lift carriage can be lowered to a level plane with relative ease and allow continued movement of the lift trolley toward the front of the carriage trolley in a manner that enables the lift carriage A-frame to mount the carriage trolley from the rear and subsequently cause the wheels of the sleeved posts of the load to dismount the carriage by means of the hinged ramps on the front of the carriage trolley and the rear carriage;

14. an improvement in a tilt-up lift trolley in claim 12 with folding metal leg braces such that when an electric hoist mounted on the folding base panel of the lift trolley with a cable extending down to and under the lower of a series of pulley wheels on a mounting bracket to and around a second pulley wheel at the center of a horizontal connecting plate at the rear of the extended frame of the lift carriage, back to a third pulley wheel on the brackets of the first pulley wheel and up to a ring at the center of the cable balanced horizontal bar which travels along the rear channel frame of the lift apparatus on trolleys is actuated the load bearing front wheels of the front A-frame will be pulled rearward toward to the center of the lift carriage for maximum load distribution and resistance to tilting of the lift carriage with the wheels of the lighter rear A-frame being nearly equidistant from the rear wheels of the lift carriage this lift carriage on which the A-frame lift apparatus is riding may be tilted with legs unfolded and the lifting trolley will descend the tracks and the carriage is dismounted with the least amount of effort, and if the lift carriage is not to be tilted for dismounting the rear wheels of the lift are pulled to removable stops at the rear end of the lift carriage tracks an mounted pulley wheels with lift cable or chain terminations or the preferred looped wheel configurations with remote termination points on the upper rear post frame to actuate lifting of the extensible mast and the simultaneous lifting of the load fork;

15. a comprehensive improvement in a lifting trolley in claim 12 where-in the combination of a base panel mounted electrical hoist with hook and cable and a balanced bar and cable assemblies which are used as an actuating means to lift a simple masts on an A-frame consisting of a parallel frame fixed at the inner base frame connection with a rotating outer end to which the lift fork is attached and operated by means of an optional balanced cable assembly mounted on the horizontal top of the prop frames or optional chain and cogwheel system assemblies which extend across wheels on the propped frame assemblies down to terminate form termination loops on wheels at the ends of second preferred rear frame mounted balanced cable assembly parallel bar which is actuated by the electric hoist with cable and hook attachments at the base of the lift assembly;

16. an improvement in a lifting trolley in claim 1 where-in a substituting chain of levers are use in the event of loss of power in pivotal manner about a central point on the lifts rear frame and connected by means of cables on the outer ends at the connected lift pedals so-as-to actuate lifting of the front mounted trolley mast by means of a balanced cable assembly which runs across cogwheels at the outer connections of the rear mounted chain prop assembly and across balanced cogwheels placed at the inner connection of the chain prop assembly so-as-to align vertically above the hook pins on the mast and pull the load which travels vertically along the a-frame channel track in the same manner as the extensible mast with a load attached load attached with the option to use longer balanced cable assemblies to lift the parallel arm at its outer frame with the lift fork attached;

17. an improvement in a lifting trolley in claim 12 wherein the lift trolley carriage is equipped with a shock absorbent tongue which sleeves within a metal channel welded to a steel tube tongue extension of the carriage trolley on the rear end and the telescoping smaller front end of the shock absorber is double bolted to a trailer hitch ball cover so-as-to reduce the lateral impact of stopping a loaded lift fork on structurally suspended floor slabs and to prevent pivotal movement within the tongue assembly to avoid jack knifing when the lift trolley carriage is pulled by a motorized tug vehicle.
